(19) United States
(12) Patent Application Publication
(10) Pub. No.: US 2007/0286982 A1
(43) Pub. Date: Dec. 13, 2007

(54) SURFACE COVERINGS AND METHODS

(76) Inventors: Kenneth B. Higgins, LaGrange, GA (US); Peter C. Brazier, Leighton Buzzard (GB); Julie A. Smallfield, Woodruff, SC (US); Dennis L. Riddle, LaGrange, GA (US)

Correspondence Address: Legal Department (M-495), P.O. Box 1926, Spartanburg, SC, 29304, US

(21) Appl. No.: 11/761,068

(22) Filed: Jun. 11, 2007

Related U.S. Application Data
(60) Provisional application No. 60/812,718, filed on Jun. 12, 2006.

(51) Int. Cl. D03D 27/00; B32B 27/12; B32B 5/28; B32B 33/00

(52) U.S. Cl. 428/95; 442/148; 442/226; 442/286; 428/96

(57) ABSTRACT

Processes, methods, uses, apparatus, and/or products such as surface coverings such as floor coverings, wall coverings, furniture coverings, or the like, having a textile or fabric show surface, decorative layer, or face and an optional backing are provided. The textile show surface, layer or face is optionally saturated, coated, and/or covered, or includes a protective film, coating composition or wear surface such as a transparent resin or polymer material. In at least one exemplary embodiment, the textile show surface is in overlying relation to a backing of or including agglomerated adjoined particle elements. In at least another exemplary embodiment, the textile show surface is in overlying relation to a backing of or including a foam cushion layer. In yet another exemplary embodiment, the textile show surface is in overlying relation to a backing which is a blend or combination of a particle and a foam backing. In particular embodiments, but not exclusively, the invention may relate to surface coverings such as floor coverings including but not limited to carpet, carpet tile, flooring, floor tile, rugs, area rugs, runners, mats, floor mats, stabilized broadloom, modular flooring, roll goods, or the like. The surface covering may incorporate a tufted, bonded, knit, woven, non-woven, needled, flocked, or the like textile or fabric show surface, face material, decorative textile layer, or the like. The textile layer may be saturated, covered, and/or coated with at least one film or film-forming composition which is desirably transparent or translucent when cured. Alternatively or in addition, the face yarn or fiber may include one or more coatings or layers such as clear, translucent and/or colored coatings or layers. For example, the face yarn may include a core yarn or fiber or filament or material covered with one or more coatings, cladding, sheaths, layers, wear layers, films, and/or the like. It is additionally desirable that the film or film-forming composition or the one or more coatings or layers is wear resistant, soil resistant, stain resistant, aesthetically pleasing, fusable, and/or the like. Optional adhesive layers, adhesive films, stabilizing layers, textile backings, films, and/or the like may be disposed above, in, and/or below the flexible and/or resilient backing. Friction enhancing, adhesive, or installation facilitating materials or coatings may be added to and/or on the underside of the backing. Alternatively or in addition, a textile or fabric backing with a friction enhancing coating may be added below the backing.

### RELATED APPLICATIONS

This application claims priority to and the benefit of U.S. Patent Application Ser. No. 60/812,718, filed Jun. 12, 2006.

### TECHNICAL FIELD

The present invention may relate to processes, methods, uses, apparatus, and/or products, for example, surface coverings such as floor coverings, wall coverings, furniture coverings, or the like, having a textile or fabric show surface, decorative layer, or face and an optional backing. Such a textile show surface, layer or face is optionally saturated, covered, and/or coated, or includes a protective coating composition or wear surface such as a transparent resin or polymer material. In at least one exemplary embodiment, the textile show surface is in overlying relation to a backing of or including agglomerated adjoined particle elements. In at least another exemplary embodiment, the textile show surface is in overlying relation to a backing of or including a foam cushion layer. In yet another exemplary embodiment, the textile show surface is in overlying relation to a backing which is a blend or a combination of a particle and a foam backing. In particular, but not exclusively, at least certain embodiments of the invention may relate to surface coverings such as floor coverings including but not limited to carpet, carpet tile, flooring, floor tile, rugs, area rugs, runners, mats, floor mats, stabilized broadloom, modular flooring, roll goods, or the like. The surface covering may incorporate a tufted, bonded, knit, woven, non-woven, needled, flocked, or the like textile or fabric show surface, face material, decorative textile layer, or the like. The textile layer may be saturated, covered and/or coated with a film or film-forming composition which is desirably transparent or translucent when cured. Alternatively or in addition, the face yarn or fiber may include one or more coatings or layers such as clear, translucent and/or colored coatings or layers. For example, the face yarn may include a core yarn or fiber or filament or material covered with one or more coatings, cladding, sheaths, layers, wear layers, films, and/or the like. It is additionally desirable that the film or film-forming composition or the one or more coatings or layers is wear resistant, soil resistant, stain resistant, aesthetically pleasing, fusable, and/or the like. In one embodiment, the textile face may be disposed in overlying relation to a resilient and/or flexible backing formed from an agglomerated mass of particles, such as fractal particles, for example particles of virgin, recycled, recyclable, renewable, natural, bio-based, bio-degradable, and/or other environmentally friendly or responsible materials, such as recycled carpet, foam, rubber, and/or cork. The textile face and the particle backing will generally be bonded together in adjoined relation. Optional adhesive layers, adhesive films, stabilizing layers, textile backings, and/or the like may be disposed above, in, and/or below the particle backing. Friction enhancing, adhesive, or installation facilitating materials or coatings may be added to and/or on the underside of the particle backing. For example, the particle backing may include voids which increase lateral grip, reduce creep, and the like. Alternatively or in addition, a textile or fabric backing with a friction enhancing coating may be added below the particle backing, below a foam backing, or below a blended or combined particle and foam backing. Methods of making and of recycling such surface coverings are also provided.

### BACKGROUND

It is known to provide carpeting and carpet tile with tufted or bonded carpet faces and with backing layers formed from so-called “virgin” or “filled” foam or from “rebond” foam wherein irregular pieces of recycled foam chips are held together by a binder. Such virgin or filled foam carpet constructions are described, for example, in U.S. Pat. Nos. 5,545,276; 5,948,500; 6,203,881; and 6,468,623 each hereby incorporated by reference as if fully set forth herein. Such rebond foam carpet constructions are disclosed for example in U.S. patent application Ser. Nos. 09/721,871 and 09/993,158 (US Published Application US 2002/0132085) and 10/209,050 (US Published Application US 2004/0022991) and British patent GB 2369294 to Higgins et al. which are each hereby incorporated by reference as if fully set forth herein.

Also, floor coverings in the form of mats or floor mats having a textile surface and a rubber backing are known. Typically, such mats include a tufted pile textile surface, for example of polyamide such as Nylon, cotton, polypropylene, or a mixture of such fibres, which is bonded to a rubber backing sheet. Such mats are usually made by bonding the textile surface layer to a sheet of uncured rubber in a heated press. The heat from the press vulcanises (cures) the rubber and at the same time bonds it to the textile layer. Such mats have very good dust control characteristics, are highly effective at removing dirt and moisture from the feet of pedestrians, and have a good feel and appearance. Certain of such mats may also be washable, durable, flexible, and lie flat on a smooth floor.

One disadvantage of many of the constructions described above is that they tend to be rather expensive, owing to the relatively high cost of the virgin backing material, they may be complex in construction, especially carpet tile, they may not be readily recycled and/or they may not contain recycled materials. Moreover, there is a general desire by manufacturers and users to increase the recycled content of manufactured products.

### SUMMARY

The present invention may relate to processes, methods, uses, apparatus, and/or products, for example, surface coverings such as floor coverings, wall coverings, furniture coverings, or the like, having a textile or fabric show surface, decorative layer, or face and an optional backing. The textile show surface, layer or face is optionally saturated, coated, and/or covered or includes a protective coating composition or wear surface such as a transparent resin or polymer material. In at least one exemplary embodiment, the textile show surface is in overlying relation to a backing of or including agglomerated adjoined particle elements. In at least another exemplary embodiment, the textile show surface is in overlying relation to a backing of or including a foam cushion layer.

In at least yet another exemplary embodiment, the textile show surface is in overlying relation to a backing of a blend or combination of a particle and foam backing. In particular, but not exclusively, at least certain embodiments of the invention may relate to surface coverings such as floor coverings including but not limited to carpet, carpet tile, flooring, floor tile, rugs, area rugs, runners, mats, floor mats, stabilized broadloom, modular flooring, roll goods, or the like. The surface covering may incorporate a tufted, bonded, knit, woven, non-woven, needled, or the like textile or fabric show surface, face material, decorative textile layer, or the like. The textile layer may be saturated, covered and/or coated with a film or film-forming composition which is desirably transparent or translucent when cured. Alternatively or in addition, the face yarn or fiber may include one or more coatings or layers such as clear, translucent and/or colored coatings or layers. For example, the face yarn may include a core yarn or fiber or filament or material covered with one or more coatings, cladding, sheaths, layers, wear layers, films, and/or the like. It is additionally desirable that the film or film-forming composition or the one or more coatings or layers is wear resistant, soil resistant, stain resistant, aesthetically pleasing, fusable, and/or the like. In one embodiment, the textile face may be disposed in overlying relation to a resilient and/or flexible backing formed from an agglomerated mass of particles, such as fractal particles, for example particles of virgin, recycled, recyclable, renewable, natural, bio-based, biodegradable, and/or other environmentally friendly or responsible materials, such as foam and/or rubber and/or cork. The textile face and the particle backing will generally be bonded together in adjoined relation. Optional adhesive layers, adhesive films, stabilizing layers, textile backings, and/or the like may be disposed above, in, and/or below the particle backing. Friction enhancing, adhesive, or installation facilitating materials or coatings may be added to and/or on the underside of the particle backing. For example, the particle backing may include voids which increase lateral grip, reduce creep, and the like. Alternatively or in addition, a textile or fabric backing such as a nonwoven felt or scrim with a friction enhancing coating may be added below the particle backing, below a foam backing or below a blended or combined particle and foam backing. Methods of making and of recycling such surface coverings are also provided.

In at least selected embodiments, the present invention may address, provide advantages or provide alternatives over the prior constructions by providing a surface covering such as a floor covering including without limitation a carpet, carpet tile, flooring, floor tile, rug, area rug, runner, mat, stabilized broadloom, modular flooring, floor mat, roll goods, and/or the like incorporating, for example, a decorative textile or fabric face defining a show surface and an optional backing such as a foam and/or particle backing of, for example, virgin, recycled, recyclable, natural, bio-based, bio-degradable, and/or renewable materials, such as natural and/or synthetic materials, for example, particles or crumbs of virgin, natural, or recycled surface covering, rubber, foam, cork, and/or the like. In accordance with one possibly preferred embodiment, the backing includes at least some recycled content at least a portion of which is particles, chips, pieces, material, or the like of, for example, recycled decorative textile or face fabric, recycled backing, recycled surface covering, or blends or combinations thereof. In accordance with a particular example, used surface coverings of at least selected embodiments of the present invention are ground into backing or filler material or particles and used in the backing of new surface coverings. The decorative face of such used surface coverings is preferably formed from a relatively flat fabric or textile of, for example, woven, knitted, or nonwoven construction.

The decorative face may be formed of colored yarns or fibers or filaments or material with or without a clear or translucent coating or layer. Alternatively or in addition, a decorative image such as text, design, color, image, and/or pattern may be applied to the textile face by printing or dyeing. Optionally after being printed or dyed, if desired, the decorative face fabric may be saturated, covered and/or coated with a film or an effective film-forming amount of protective film-forming composition, for example, a transparent or translucent wear resistant, stain resistant or soil resistant composition such as a clear resin or polymer, for example, polyurethane, acrylic, polyester, polyolefin, polyamide, high-density polyolefin, high-density polypropylene (HDPP), blends or combinations thereof, or the like. If desired, a stabilizing layer for example constructed of glass such as fiberglass, a glass mat, glass scrim, woven glass, or the like may be employed above, on, in, and/or below the backing, or for the backing. In one possibly preferred construction, the stabilizing layer may be embedded within the particle and/or foam backing. A textile backing layer may also be applied across the underside of the backing. A friction enhancing coating or material may be added across the underside of the particle and/or foam backing or the underside of the textile backing.

Although in accordance with at least selected embodiments, the surface coverings have a particle backing, it is contemplated that the surface coverings may have adhesive, resin, polymer, fabric, textile, foam, and/or the like backings or backing layers. For example, floor tiles of at least certain possibly preferred embodiments may have hardback or cushion back particle, foam, adhesive, resin, polymer, fabric, textile, extruded, film, and/or the like backings or backing layers along with one or more optional adhesive layers, adhesive films, stabilizing layers, textile backings, coatings, or materials.

According to one possible aspect of the present invention, there is provided a method of making a surface covering with a textile or fabric surface and a resilient and/or flexible backing having a substantial percentage of recycled material. In a potentially preferred practice, the method includes mixing particles of recycled material, for example, particles of recycled surface coverings, rubber, foam, cork, and/or the like with a binder optionally with the addition of one or more fillers, agents or compounds, depositing the particle/binder mixture in a layer, placing a saturated, covered and/or coated textile surface material on the layer to form a multi-layer structure, pressing the multi-layer structure while setting the binder with, for example, heat so that the particles are consolidated to form a resilient and/or flexible backing. Generally, the resilient backing will include voids between the pressed particles and the coated textile surface material will be bonded to the backing. The coated textile surface material may be made of colored yarns or fibers or filaments or material and/or printed or dyed before or after it is coated or covered. One or more additional protective, stain resistant, soil resistant, or wear layers or films may be added over the coated textile surface material. Alternatively or in addition, the yarns or fibers or filaments or material of the surface material may be coated with such materials. For example, the face yarn may be a coated yarn such as a polyolefin yarn extrusion coated with a colored polyolefin polymer material over coated with a clear polymer wear layer. If the coated face yarn is made out of a single polymer or material, it may be easier to recycle. For example, a yarn having a polyolefin core and a polyolefin coating may be easier to recycle than a multi-polymer or multi-material yarn. In a particular example, a preferred yarn may have a polypropylene core and a polypropylene coating.

Throughout this specification the terms “particles”, “powder”, “granules”, “chips” or “crumbs” are used to designate elements of virgin, renewable, recycled, recyclable, natural, bio-based, bio-degradable, and/or other environmentally friendly or responsible materials, such as elements of glass, cork, foam, rubber, flooring, decorative face, backing, and/or the like that have been “broken down” by chopping, mechanical grinding, cryogenic grinding, or other known techniques or suitable combination techniques as will be known to those of skill in the art. Thus, a particle or crumb of cork, foam, or rubber utilized within the contemplated practices can be any size in a range that includes powder, granules and chips. For the purpose of describing at least selected embodiments herein, the term “powder” means particles or crumbs that will pass a 2 mm mesh or with a maximum dimension of 2 mm in at least one dimension as the context requires. “Granule” or “granules” means particles or crumbs that will pass a 6 mm mesh or with a maximum dimension of 6 mm in at least one dimension, as the context requires. Granules may include some powder but are generally larger than powder and have a weight average size that is near to the maximum of the size specification for the granule. “Chips” means particles or crumbs that are larger than granules. That is, larger than 6 mm in at least one dimension as the context requires. Regardless of actual dimension, it is contemplated that the particles or crumbs are preferably characterized by substantially fractal irregular surface configuration although other shapes or configurations may be used such as cylindrical, pellet, oval, disc, rod, spherical, or the like.

It should be noted that any batch of particles normally contains a proportion smaller than the nominal particle size. Thus, for example, it has been found that rubber particles made using a granulator with a 1.5 mm screen (i.e. having holes of diameter 1.5 mm) had a distribution of sizes, measured by using standard “Endecott” test sieves (ISO3310-1:2200, BE410-1:2000, ASTM E11:95), comprising by weight 72.82% in the range 1.0-2.0 mm, 17.45% of 0.71-1.0 mm, 6.90% of 0.5-0.71 mm, 2.65% of 0.25-0.5 mm and 0.18% of 0-0.25 mm. Therefore, in the present specification, where we refer to 1.5 mm crumb or particle size, it is meant that the particles are generated using a granulator with a 1.5 mm screen. Likewise, it is to be understood that where reference is made to “setting” the binder, we mean any suitable method of setting the binder, for example using techniques such as curing, hardening, fixing, or heat-setting the binder. The skilled person will know which method of setting to use, usually depending on the nature of the binder. The binder may be selected from the group including thermosetting and water curable polymeric materials, adhesives, and mixtures thereof. The binder may alternatively be selected from the group including thermoplastic polymeric materials, hot melt binders, adhesives, extrudable materials, and mixtures thereof.

According to another contemplated practice, the assembled layers are pressed at a temperature of from about 50° C. to about 200° C., preferably from about 110° C. to about 180° C., and most preferably approximately from about 125° C. to about 177° C.

The assembly may be pressed in a plurality of stages including a low temperature stage and a higher temperature stage. Depending on requirements, the low temperature stage may be employed first with a later higher temperature stage or vice versa. For example, if the binder is selected from the group including thermosetting and water curable polymeric materials and mixtures thereof, the assembly is preferably pressed in a plurality of stages including at least one low temperature stage followed by at least one higher temperature stage. Alternatively, for example if the binder is selected from the group including thermoplastic polymeric materials, hot melt binders and mixtures thereof, the assembly is preferably pressed in a plurality of stages including at least one high temperature stage followed by at least one lower temperature or cooling stage.

The assembly may be pressed between a pair of opposing compressive belts (double belt laminator) although other equipment such as one or more rollers with an optional film or fabric between the rollers and the assembly or a press having an inflatable diaphragm may likewise be used when it is desired to cure the assembly under pressure.

A continuous sheet of textile material may be laid on the particle/binder layer. The textile material being laid is optionally a saturated, covered or coated textile material. Alternatively, or additionally to the continuous sheet, separate textile elements may be laid consecutively on the particle/binder layer. If desired, a layer of adhesive such as an adhesive film, dry adhesive, or other resilient adhesive may be disposed between the textile face and the particle/binder layer, between the textile face and a stabilizing layer or material, between a stabilizing layer or material and the particle/binder backing, and/or below the particle/binder backing to facilitate adhesion between layers.

In the event that rubber particles are used, such rubber is preferably recycled EPDM or nitrite rubber. EPDM is a term used to designate a rubber mixture of which the main polymeric content is an ethylene propylene diene rubber monomer. It may also have fillers, plasticisers and other ancillary components as will be known in the rubber compounding industry. The EPDM particles may be either foam or solid particles. Nitrile rubber is a term used to describe a compounded rubber mixture of which the main polymeric content is an acrylonitrile butadiene copolymer. It may also contain one or more of fillers such as carbon black, a curing system, plasticisers and other ancillary components. Other rubber materials such as SBR rubber particles, recycled tire crumb, recycled mat crumb, recycled mat backing crumb, rubber blends, and combinations thereof may also be used.

In the event that foam particles are used, such foam is preferably a recycled urethane foam or EPDM foam. Such foams, and in particular urethane foams, may be mechanically frothed and/or chemically blown and may be of either open or closed cell construction. Other foams such as rebond foam, waste rebond foam, nitrile foam, SBR foam, recycled mat crumb, recycled foam mat backing, recycled foam backed flooring, recycled flooring foam backing, other recycled foam material, blends thereof, combinations thereof, and the like may also be used.

In at least one embodiment, the particle/binder backing has a density of less than about 1 g/cm³. In at least one embodiment, the particle/binder backing preferably has a density in the range from about 0.5 to about 0.9 g/cm³, more preferably from about 0.7 to about 0.9 g/cm³.

In at least one embodiment, the particle/binder backing exhibits a tear resistance strength of at least about 0.8N/mm², and more preferably the tear resistance strength of the particle/binder backing is about 1.5N/mm² or higher.

Advantageously, in accordance with at least selected embodiments, the textile surface or face comprises a relatively flat textile or fabric construction, for example, of a tufted, flocked, needled, nonwoven, knit, or woven textile construction. Such materials may be formed, woven, knit, printed and/or jet dyed with decorative surface designs if desired. The textile material is preferably saturated, covered or coated with at least one clear protective film or film-forming composition such as polyurethane, acrylic, polyester, or the like (preferably at least transparent or translucent after curing). The textile material may be saturated before or after printing, dyeing, texturing, backing, or the like. In at least one embodiment, the textile material is preferably printed or dyed prior to being saturated. Using one or more sublimation printing techniques, the textile material may be printed after being saturated, covered or coated, for example, with a transparent material. Full saturation or fully saturated means saturated, penetrated or soaked through the textile and covered sufficiently to form a protective, outer film, coating, or the like. The textile surface or face may be saturated or coated all at once by, for example, a dip coater, or may be coated and saturated by being coated on one side and then the other (top and bottom), for example, by a roll coater on each side followed by a nip roller. Full saturation may be accomplished in multiple steps or a single step. Further, one material may be coated on the bottom of the textile, such as an opaque hot melt, adhesive, latex material or methylene diphenyl diisocyanate (MDI) binder, and another material may be coated on the top of the textile, such as a transparent polyurethane, polyester, acrylic, or the like. Alternatively, one or more films may be placed on the top and/or on the bottom of the textile surface or face material. For example, in selected embodiments, a clear, transparent or translucent resin or polymer film or films may be preferred, such as polyester, polyurethane, polyolefin, blends thereof, combinations thereof, or the like. For example, a first polyurethane film may be placed or extruded on top of the textile, then a polyester film may be placed or extruded over the polyurethane film. In other select embodiments, one or more colored, white patterned, printed, or other opaque films may be used. For example, a white film may be placed or extruded over the textile, printed, and then covered with one or more clear films. When cured or heated, the multiple film layers may fuse and form a unitary structure. As an alternative example, the top of the textile may be covered with a first thin film adhesive, a second opaque film, and a third transparent film or wear layer. Likewise, the bottom of the textile face material may have one or more films or coatings on the bottom thereof such as one or more adhesive films, stabilizing films, combinations thereof, or the like. Depending on the films or coatings used, one or more thereof may serve, for example, as wear layers, cover layers, aesthetic color, pattern or print layers, moisture barriers, adhesive layers, stabilizing layers, backings, and the like. Hence, the textile face or surface material may be coated, covered or saturated with one or more materials in one or more steps. One or more additional preferably transparent stain resist, soil resist, and/or wear resist layers may be added over the coated textile surface material. Alternatively or in addition, the yarns or fibers of the textile or fabric surface material may be coated with such materials. For example, the face yarn may be a coated natural and/or synthetic fiber or yarn such as a polyester or polyolefin single or multi-fiber white or colored yarn extrusion coated with a clear or colored polyolefin or PVC polymer material over coated with a clear polymer wear layer or film such as a high density polypropylene, polyester, acrylic, polyurethane, blends thereof, combinations thereof, or the like.

In accordance with at least one embodiment, the present invention may relate to surface coverings such as floor coverings, wall coverings, furniture coverings, or the like, having a coated yarn textile show surface or face and an optional backing. The coated yarn textile show surface or face is optionally saturated, covered, coated, or includes a protective coating composition or wear surface such as at least one transparent resin or polymer material. In at least one exemplary embodiment, the coated yarn textile show surface is in overlying relation to a backing of or including agglomerated adjoined particle elements. In at least another exemplary embodiment, the coated yarn textile show surface is in overlying relation to a backing of or including a foam cushion layer. In particular, but not exclusively, the coated yarn textile face surface covering is preferably a floor covering including but not limited to carpet, carpet tile, flooring, floor tile, area rugs, rugs, runners, mats, floor mats, stabilized broadloom, modular flooring, roll goods, or the like. The surface covering may incorporate a tufted, bonded, knit, woven, non-woven, needled, flocked, or the like decorative coated yarn textile layer. The coated yarn textile layer may be saturated, or covered, or coated with at least one film or film-forming composition which is desirably transparent or translucent when cured. Alternatively or in addition, the face coated yarn or fiber may include one or more coatings or layers such as clear, translucent or colored coatings or layers. For example, the face yarn may include single or multiple fibers (staple or continuous), filaments (including continuous filament and monofilament) or strips of material that are white, clear, or colored and form a core yarn or filament (such as monofilament) or material covered with one or more coatings, cladding, sheaths, wear layers, and/or the like. It is additionally desirable that the at least one film or film-forming composition or the one or more coatings or layers is wear resistant, soil resistant, stain resistant, aesthetically pleasing, fusable, printable, and/or the like. In one embodiment, the coated yarn textile face may be disposed in overlying relation to a resilient backing formed from an agglomerated mass of particles, such as fractal particles, for example particles of virgin, recycled, recyclable, renewable, natural, and/or other environmentally friendly materials, such as virgin and/or recycled flooring, tiles, mats, tires, weather stripping, coated yarn surface coverings, foam, rubber, cork, glass, blends thereof, combinations thereof, or the like. The textile face and the resilient backing will generally be bonded together in adjoined relation. Optional adhesive films or layers, stabilizing layers, textile backings, and/or the like may be disposed above, in, and/or below the resilient backing. Friction enhancing, adhesive, or installation facilitating materials may be added to and/or on the underside of the backing. For example, the particle backing may include voids which increase lateral grip, reduce creep, and the like. Alternatively or in addition, a felt backing with a friction enhancing coating, material, embossing, or the like may be added below the particle backing or below a foam backing layer. The coated face yarn may be a coated natural and/or synthetic fiber or filament or material yarn such as a single or multiple fiber, filament or material polyester or polyolefin clear, white, or colored yarn extrusion coated with a clear, white or colored polyolefin or PVC polymer material over coated with a clear polymer wear layer or film such as a high density polypropylene. Methods of making and recycling such coated yarn surface coverings are also provided.

### BRIEF DESCRIPTION OF THE DRAWINGS

At least certain exemplary embodiments or aspects of the invention will be described by way of example only and with reference to the drawings, which are briefly described as follows:

FIG. 1 is a cross-sectional side elevation of an exemplary surface covering element having a fabric show surface and illustrating layered constituent elements and an optional additional upper film or layer such as a protective layer and an optional lower film or layer such as a friction enhancing or adhesive layer;

FIG. 2 is a side elevation of an exemplary process line for manufacturing a surface covering, such as the surface covering of FIG. 1 as well as others, incorporating, for example, a fabric show surface and a particle backing, such as a rubber particle and binder backing;

FIG. 2A is a side elevation view similar to FIG. 2 illustrating an exemplary process line for manufacturing a surface covering, such as the surface covering of FIG. 7 as well as others with or without the textile backing 452, incorporating, for example, a fabric show surface, an optional adhesive layer, and a preformed particle backing such as a rebond foam backing;

FIG. 2B is a side elevation view like FIG. 2 illustrating an alternative exemplary process line for manufacturing a surface covering, such as the surface covering of FIG. 1 as well as others, having a fabric show surface and a particle backing;

FIG. 3 is a cross-sectional side view similar to FIG. 1 illustrating an alternative exemplary surface covering element having a fabric show surface adhesively bonded to a stabilized particle backing with an underlying backing sheet and optional additional upper and/or lower layers;

FIG. 4 is a side elevation of an exemplary process line for manufacturing a surface covering, such as a surface covering having the layered construction illustrated in FIG. 11 or in FIG. 3 as well as others, incorporating a fabric show surface and a particle backing or a fabric face adhesively bonded to a stabilized particle backing such as a rubber particle and binder backing with optional upper and lower layers;

FIG. 4A is a side elevation view similar to FIG. 4 illustrating an exemplary process line for manufacturing a surface covering having, for example, the layered construction illustrated in FIG. 3 as well as others, incorporating a fabric show surface adhesively bonded to a stabilized preformed particle backing such as a rebond foam backing having, for example, two preformed rebond foam layers and optional additional layers;

FIG. 5 is a cross-sectional side view illustration of an exemplary surface covering similar to FIG. 1 with the inclusion of a textile backing such as a fibrous backing sheet;

FIG. 6 is a cross-sectional side view of an exemplary surface covering element similar to FIG. 3, FIG. 5, or FIG. 7 illustrating an alternative construction having a fabric show surface adhesively bonded to a stabilized particle backing with an underlying backing sheet and optional additional layers;

FIG. 7 is a cross-sectional side view of an exemplary surface covering element similar to FIG. 3, FIG. 5 or FIG. 6 illustrating an exemplary construction having a fabric show surface adhesively bonded to a particle backing with an underlying backing sheet and with optional additional layers;

FIG. 8 is a cross-sectional side view illustration of an exemplary surface covering element similar to FIG. 1, FIG. 5 or FIG. 7 incorporating a layer of adhesive bonding a fibrous backing sheet;

FIG. 9 is a cross-sectional side view illustration of an exemplary surface covering element similar to FIG. 8 or FIG. 7 incorporating a layer of adhesive on either side of a particle backing layer;

FIG. 10 is a cross-sectional side view that illustrates an exemplary surface covering element having a construction similar to FIG. 6 incorporating a combination of stabilizing layers such as glass mat and scrim stabilizing layers;

FIG. 11 is a cross-sectional side view illustration of an exemplary surface covering element similar to FIG. 3 but excluding at least certain adhesive additions;

FIG. 12 is a top plan view of an exemplary surface covering element such as a tile product incorporating a decorative show surface and optional upper layer such as an additional protective layer or layers and texturing such as embossing;

FIG. 13 is a side view taken along line 13-13 in FIG. 12 illustrating the surface covering element of FIG. 12 having a backing and optional lower layer;

FIG. 14 is a top plan view of an exemplary surface covering element such as a tile product incorporating a decorative show surface with outboard border zones and optional upper layer such as an additional protective layer or layers and texturing such as embossing;

FIG. 15 is a side view taken along line 15-15 in FIG. 14 illustrating the surface covering element of FIG. 14 having a backing and optional lower layer;

FIG. 16 is an enlarged cross-sectional end view that illustrates an exemplary coated yarn in accordance with one embodiment of the face construction of the present invention;

FIG. 17A is an enlarged cross-sectional end view that illustrates an alternative exemplary coated yarn in accordance with another embodiment of the face construction;

FIG. 17B is an enlarged cross-sectional side view taken along line 17B-17B in FIG. 17A that illustrates a length of the coated yarn of FIG. 17A;

FIG. 18 is an enlarged cross-sectional end view that illustrates still another exemplary coated yarn, fiber, filament, or material in accordance with still another embodiment of the face construction;

FIG. 19 is an enlarged cross-sectional end view that illustrates another alternative exemplary coated yarn, fiber, filament, or material in accordance with another embodiment of the face construction;

FIG. 20 is an enlarged cross-sectional end view that illustrates yet another exemplary coated yarn (or yarns) having multiple core yarns in accordance with yet another embodiment of the face construction;

FIGS. 21A-21D are respective enlarged cross-sectional end views that illustrate respective exemplary face fiber, filament, or material shapes in accordance with respective alternative embodiments of the face construction;

FIG. 22 is a cut-away side view illustration of an exemplary alternative embodiment of a woven face surface covering such as a woven face flooring construction;

FIG. 23 is a cut-away side view illustration of an exemplary woven face surface covering incorporating a potentially preferred foam backing structure;

FIG. 24 is a cut-away side view illustration of an exemplary tufted face surface covering incorporating a potentially preferred foam backing structure;

FIG. 25 is a cut-away side view illustration similar to FIG. 24 of an alternative tufted face surface covering having short cut pile;

FIG. 26 is a cut-away side view illustration similar to FIG. 24 of an alternative tufted face surface covering having short or tight loop pile;

FIG. 27 is a cut-away side view illustration similar to FIG. 22 of an alternative non-woven face surface covering; and

FIG. 28 is a cut-away side view illustration similar to FIG. 22 of an alternative needled or needle punched face surface covering.

### DESCRIPTION OF THE EMBODIMENTS

The present invention may relate to processes, methods, uses, apparatus, and/or products such as surface coverings such as floor coverings, wall coverings, furniture coverings, or the like, having a textile or fabric show surface, decorative layer, or face and an optional backing. The textile show surface, layer or face is optionally saturated, coated, and/or covered, or includes a protective coating composition or wear surface such as a transparent resin or polymer material. In at least one exemplary embodiment, the textile show surface is in overlying relation to a backing of or including agglomerated adjoined particle elements. In at least another exemplary embodiment, the textile show surface is in overlying relation to a backing of or including a foam cushion layer. In yet another exemplary embodiment, the textile show surface is in overlying relation to a backing which is a blend or combination of a particle and a foam backing. In particular, but not exclusively, at least one embodiment of the invention may relate to surface coverings such as floor coverings including but not limited to carpet, carpet tile, flooring, floor tile, rugs, area rugs, runners, mats, floor mats, stabilized broadloom, modular flooring, roll goods, or the like. The surface covering may incorporate a tufted, bonded, knit, woven, non-woven, needled, or the like textile or fabric show surface, face material, decorative textile layer, or the like. The textile layer may be saturated, covered or coated with film-forming composition which is desirably transparent or translucent when cured. Alternatively or in addition, the face yarn or fiber may include one or more coatings or layers such as clear, translucent and/or colored coatings or layers.

For example, the face yarn may include a core yarn or fiber, filament, or material covered with one or more coatings, films, cladding, sheaths, layers, wear layers, and/or the like. It is additionally desirable that the at least one film or film-forming composition or the one or more coatings or layers is wear resistant, soil resistant, stain resistant, aesthetically pleasing, fusable, and/or the like. In one embodiment, the textile face may be disposed in overlying relation to a resilient backing formed from an agglomerated mass of particles, such as fractal particles, for example particles of virgin, recycled, recyclable, renewable, natural, bio-based, biodegradable, and/or other environmentally friendly materials, such as virgin or recycled face materials, backing materials, surface coverings, foam, rubber, cork, blends thereof, combinations thereof, or the like. The textile face and the resilient backing will generally be bonded together in adjoined relation. Optional adhesive layers, adhesive films, stabilizing layers, textile backings, and/or the like may be disposed above, in, and/or below the resilient backing. Friction enhancing, adhesive, or installation facilitating materials or coatings may be added to and/or on the underside of the backing. For example, the particle backing may include voids which increase lateral grip, reduce creep, and the like. Alternatively or in addition, a textile or fabric backing with a friction enhancing coating may be added below the particle backing or below a foam backing layer. Methods of making and of recycling such surface coverings are also provided.

In at least selected embodiments, the present invention may address, provide advantages or provide alternatives over the prior constructions by providing a surface covering such as a floor covering including without limitation a carpet, carpet tile, flooring, floor tile, area rug, rug, runner, mat, stabilized broadloom, modular flooring, floor mat, roll goods, and/or the like incorporating, for example, a decorative textile or fabric face defining a show surface and a hardback of cushion back backing such as a foam and/or particle backing of, for example, virgin, recycled, recyclable, and/or renewable materials, such as natural and/or synthetic materials, for example, particles (powder, granules and/or crumbs) of preferably recycled materials and fillers such as recycled surface coverings, flooring, face fabric, backing, rubber, foam, cork, blends thereof, combinations thereof and/or the like. The decorative face of such surface coverings is preferably formed from a flat fabric or textile of woven, knitted, or nonwoven construction although tufted, flocked, or needled constructions may be used. The decorative face may be formed of colored yarns or fibers or filaments or materials with or without a clear or translucent coating or layer. Alternatively or in addition, a decorative image such as a printed text, design, color, image, or pattern may be applied to the textile face by printing or dyeing. Optionally after being printed or dyed, if desired, the decorative face fabric may be saturated, covered, or coated with a film or an effective film-forming amount of protective film-forming composition, for example, a transparent or translucent wear resistant, stain resistant or soil resistant composition such as a clear resin or polymer, for example, polyurethane, acrylic, polyester, polyolefin, polyamide, high-density polyolefin, or the like. If desired, a stabilizing layer for example constructed of glass such as fiberglass, glass fiber, glass mat, glass scrim, or the like may be employed on or in or for the backing. In one possibly preferred construction, the stabilizing layer may be embedded within the particle backing. A textile backing layer may also be applied across the underside of the foam or particle backing. A friction enhancing coating or material may be added across the underside of the foam or particle backing or the underside of the textile backing.

Although in accordance with at least selected embodiments, the surface coverings have a particle backing, preferably a resilient or flexible particle backing, it is contemplated that the surface coverings may have other adhesive, resin, polymer, fabric, textile, foam, and/or the like backings or backing layers. For example, floor tiles of at least certain possibly preferred embodiments may have hardback or cushion back, particle, foam, adhesive, resin, polymer, fabric, textile, and/or the like backings or backing layers along with one or more optional stabilizing, backing or friction enhancing layers.

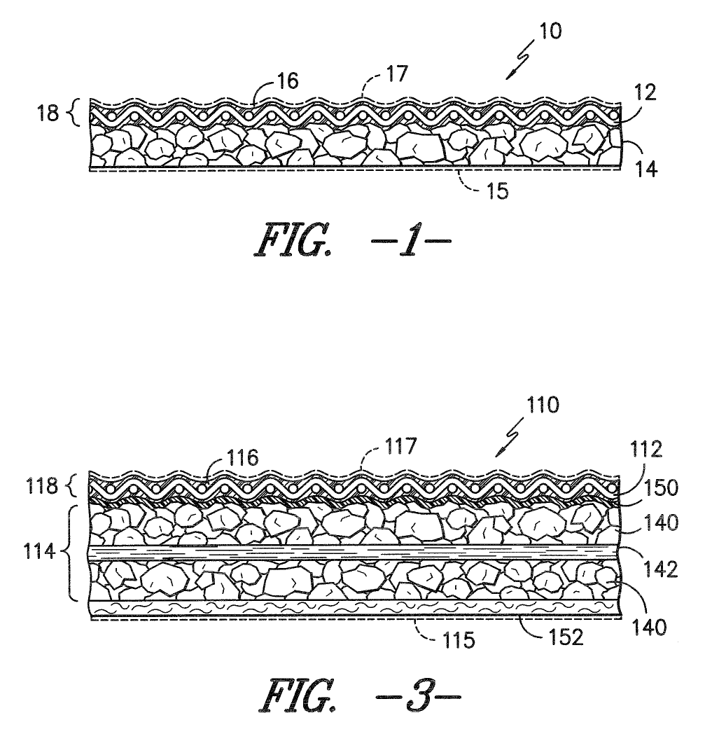

With reference to FIG. 1 of the drawings, an exemplary embodiment of a surface covering 10 such as a floor covering, for example, a carpet, carpet tile, flooring, floor tile, modular flooring, area rug, rug, runner, mat, floor mat, roll goods, stabilized broadloom, or the like is illustrated in cross section. As will be appreciated, for ease of understanding, the various layers are illustrated with enhanced dimensions. Thus, the illustrated dimensions do not necessarily correspond to final relative thickness levels in the layers or final construction.

As shown, in the illustrated exemplary embodiment of FIG. 1, the surface covering 10 includes an exterior composite layer 18 including a textile show surface 12 of preferably substantially fiat woven, nonwoven or knit fabric or textile construction preferably saturated or coated with an optional wear resistant film-forming composition 16 that defines an encapsulating protective barrier across the textile show surface 12. Composite 18 may include one or more additional optional protective, wear resist, stain resist, soil resist, and/or the like layers, films, coatings or like 17 preferably transparent or translucent at least when cured. The exterior composite layer 18 is disposed in overlying relation to a single or multi-layer optional backing structure 14 as will be described further hereinafter incorporating, for example, an agglomerated mass of particles such as virgin, recycled, recyclable, renewable, natural, bio-based, bio-degradable, and/or other environmentally friendly or responsible materials, for example, recycled flooring, foam, rubber, cork, and/or glass particles. As will be appreciated, the term “flat” used in reference to the textile show surface is intended to refer to the preferably non-pile or low pile face contour of the show surface 12 rather than to any particular formation technique. In this regard, it is to be understood that flat fabrics may include relatively level low profile face fabrics such as plush, napped or sanded face fabrics. Textile or fabric 12 may be mesh, net, open weave, tight weave, short loop, short tight loop, short pile, very short pile, needled, bonded, tufted, flocked, woven, nonwoven, knit, tufted, multi-level, textured, pattern textured, and/or the like. By way of example only, and not limitation, one process for forming a knit or knitted plush fabric is disclosed in U.S. Pat. No. 5,916,273 the contents of which are incorporated herein by reference. Fabrics of the type disclosed in U.S. Pat. No. 5,916,273 are suitable for use in at least certain embodiments of the surface coverings of the present invention. While ribbed fabrics may be used if desired, fabrics with substantially level surfaces such as plain woven, flat woven, nonwoven, needled, and warp knit fabrics may be preferred. Of course, such fabrics necessarily have some degree of irregularity across the surface due, for example, to yarn cross-over points, embossing, and the like. The show surface 12 is preferably visible through the preferably transparent or translucent film formed by the saturating film-forming composition 16 and any additional layers 17 and is thus visible to a product user or purchaser.

In at least selected embodiments, the textile show surface 12 is preferably a woven or knit material such as a natural and/or synthetic yarn, fiber, filament or material, for example, a polyester of multi-filament spun yarn construction and more desirably of the type wherein the yarns are characterized by linear density levels in the range of from about 50 to about 2500 denier. By way of example only, one contemplated textile show surface is an office panel fabric of woven jacquard construction formed from 150 denier textured polyester with a formation construction of about 128 ends per inch (2.54 cm) by about 42 picks per inch (2.54 cm) with a mass per unit area of about 6.1 ounces per square yard (205.88 grams/m2) prior to saturation. Another contemplated textile show surface is an office panel fabric of woven jacquard construction formed from 150 denier textured polyester yarn with a formation construction of about 132 ends per inch (2.54 cm) by about 51 picks per inch (2.54 cm) with a mass per unit area of about 5.4 ounces per square yard (182.25 grams/m2) prior to saturation. Still another contemplated textile show surface is a seating fabric of knit construction formed from 1/800/1 elastomeric polyester in combination with 3/150/36 textured polyester with a formation construction of about 14 wales per inch (2.54 cm) by about 20 courses per inch (2.54 cm) with a mass per unit area of about 13.5 ounces per square yard (455.63 grams/m2) prior to saturation. The textile show surface 12 may be either of solid coloration or may have a decorative coloration, image, design, or pattern woven, tufted, formed, printed, or dyed thereon. For example, a pattern, design, color, shade, or the like may be formed by using colored fibers or yarns such as yarn dyed or solution dyed, formed by piece dyeing, formed by printing or may be jet dyed on a textile show surface made for example from white or light or light colored yarn or fiber or filament or material. Any printing, dyeing or other coloration is desirably done prior to saturation. Alternatively, one or more sublimation printing techniques may be used to print or dye the textile show surface after saturation.

As previously indicated, the textile show surface 12 is preferably saturated, penetrated, encapsulated, coated, or covered with a preferably wear resistant see-through film formed from a suitable film-forming composition 16 and one or more optional additional layers, films, coatings, or the like 17 that defines an encapsulating protective barrier across the textile show surface 12. The terms “full saturation” or “fully saturated” as employed herein with reference to the described embodiments are used to indicate that an amount of film-forming composition effective to saturate, penetrate, or soak through the textile or fabric 12 and to form a film on both sides is employed. To establish an effective barrier, the film-forming composition 16 is preferably applied at a level sufficient to fully saturate the textile thereby forming at least a thin film across both sides (face and back) of the fabric forming the textile show surface 12. Full saturation and penetration is preferred as it may prevent shade variations, strengthen the face, enhance durability, enhance dimensional stability, and/or the like. The film forming composition 16 and any additional layers 17 are preferably sufficiently transparent in a final cured state so as to avoid interference with the decorative character of the textile show surface. The additional layers and the film-forming composition is preferably extrudable or a liquid for example a polyester, urethane or acrylic such as is readily available for coating hard wood floors and the like although other suitable transparent or translucent protective films or film forming compositions such as polyester or the like may likewise be utilized if desired. The add on weights of composition or material 16 should preferably be adequate to fully saturate and penetrate the textile show surface material 12 thereby surrounding and encapsulating such textile show surface material.

As previously indicated, the backing structure 14 preferably is formed from a mass of particles, such as renewable, recyclable, and/or recycled solid or foam particles, such as virgin, natural, or recycled cork, foam, rubber, and/or other particles or blends thereof, or combinations thereof, attached together using at least one binder material such as a resilient or hard binder that bonds each particle to adjacent particles alone or together with other materials, agents, fillers, additives, and/or the like. The particles are preferably of a substantially irregular fractal surface geometry to provide a high surface area for bonding. However, spheroidal, pellet, cylindrical, disc, rod, oval, and/or other relatively smooth surface geometries may be used if desired. For example, compressible and/or noncompressible spherical particles such as rubber or ceramic spheres may be employed. In the embodiment illustrated, the binder also bonds the backing structure 14 to the protective or film-forming composition 16 on the underside of the exterior composite layer 18. As will be appreciated, within the backing structure interstitial voids may exist between the particles, some of which may be partially or fully filled with the binder, fillers, additives, etc. If desired, maintaining voids and/or using a resilient binder may provide substantial resiliency and cushioning. A certain number of voids may also reduce mass, reduce cost, increase flexibility, enhance lateral grip, reduce creep, and/or the like. At least when using a liquid binder, it is preferred that each of the particles of the backing be encapsulated with at least a thin layer of binder. This aids in bonding the particles together and in bonding the backing 14 to the face composite 18.

In the event that the particles of the backing structure are rubber, nitrile rubber or EPDM may be preferred. By way of example, one contemplated source of EPDM is recycled weather stripping. Such EPDM may be either of hard or resilient (foam) character. By way of example only, one contemplated source for nitrile rubber is from recycled industrial mats. The rental industrial segment is an ideal source of raw material for the rubber particles because it ensures that low bleed, low staining nitrile rubber is used as the starting point for the production of the surface coverings. Rubber from recycled tires may also be used if desired.

Recycled SBR rubber may also be used. In the event that the particles of the backing structure are foam, cellular polyurethane foam may be preferred. Other rubber materials (solid or foam) may be used. Also, other recycled fillers or materials may be used such as ground or recycled surface coverings, show face, backing, flooring, glass, coal fly ash, gypsum, bone meal, used foundry sand, blends thereof, combinations thereof, or the like. In accordance with at least one embodiment, the fillers are preferably ground to a size less than 50 mesh, more preferably less than 100 mesh, most preferably less than 350 mesh.

It is contemplated that the size of backing structure particles, such as foam, rubber or cork particles, utilized should preferably range from about 0.01 to about 15 mm. However, larger or smaller particle sizes may be used if desired. Generally, the size is selected to be as large as possible for the use and properties required. It has been found that particle size can be chosen to give different amounts of resilience in the product. Larger particles generally provide greater resilience. Particles of a desired size may be mixed with powder of the same material or a different material to provide a greater tear resistance. Powder may increase the tensile strength for a given binder level. The use of other additives in powdered or liquid form may provide the same or different advantages. Suitable additives include, but are not limited to, magnetic or magnetizable particles, anti-microbial materials, anti-flammability additives, odorants, colorants or pigments such as iron oxide powder, anti-static additives such as carbon fibres, fillers and/or other generally known additives.

Also, one may combine hard and resilient chips, particles or crumbs of the same material or different materials. For example, one may mix foam EPDM particles with solid filler particles and with binder.

The binder used to adjoin the particles of backing 14 may be, for example, either a water curing, heat setting and/or thermoplastic type. Depending on the process utilized to manufacture the backing, the binder can be in liquid or powder form. Preferably, the binder is selected from one of the following types: polyurethane reactive hot melts, copolyester or copolyamide reactive and thermoplastic hot melts, and 4,4-methylene di-p-phenylene isocyanate (MDI) polyurethane one- and two-component adhesives. The binder may be on or in or part of the particles or filler or the like used in the backing. For example, agglomerated particles of recycled carpet tile having at least one hot melt layer in the carpet tile may form both the particles and binder (self-binding particles).

It is important that the binder has good adhesive properties to ensure that the particles are well bound, and it is additionally desirable that sufficient free binder is provided to be capable of forming a physical or chemical bond to the exterior surface of, for example, face composite 18, stabilizing layer 142, backing 152, and/or the like. The binder should also desirably exhibit sufficient cohesive strength to give the backing sufficient strength. The binder may contain any of the known cross linkers or curing accelerators to suit the process and the desired properties of the product being manufactured and the particles being used.

In accordance with one possible preferred embodiment, a particle backing or hybrid particle/foam backing is created by adding particles, chips, filler, and/or the like to a polymer foam forming composition or puddle. For example, particles of recycled carpet tile, flooring, and/or other surface covering are added to a liquid polyurethane foam forming composition to create a hybrid backing using the foam forming composition (which usually forms a foam cushion layer) as the binder or carrier for the added particles.

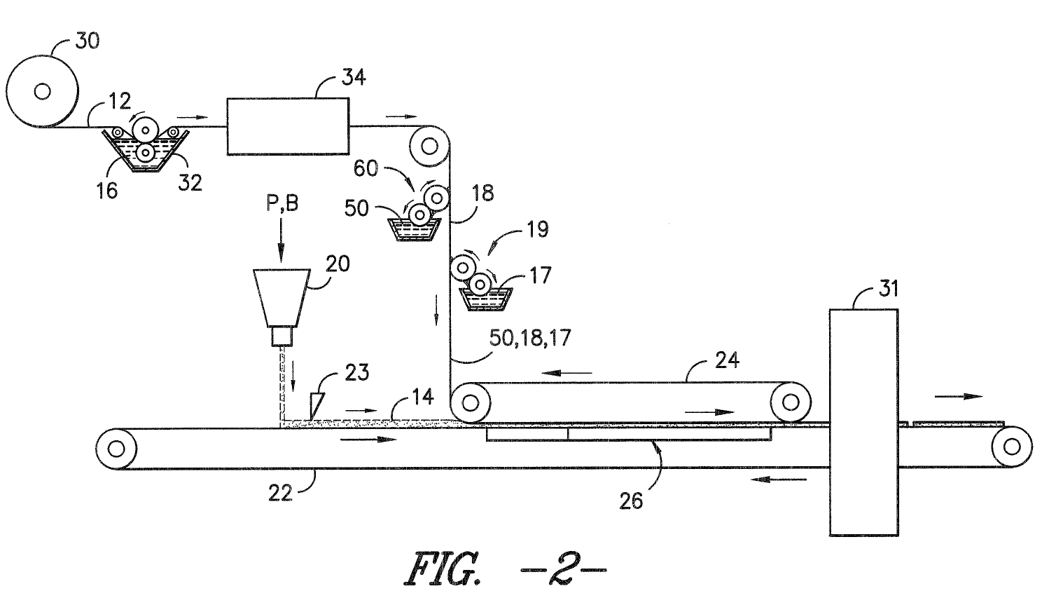

In the illustrated embodiment of FIG. 1 (and with reference for example to FIGS. 2 and 2B), the binder performs the dual function of holding together the particles to form a backing 14 and bonding the backing 14 to the bottom of the exterior of composite layer 18. To perform both functions, binder levels should preferably be in the range from about 2% to about 20% by weight of the particles. Use of lower particle sizes may dictate the use of higher percentages of binder due to greater surface area. In particular, the use of fine powders of size less than about 0.5 mm may require about 20% binder or more.

Generally, there is an inverse relationship between the binder content and size of the particles and between the binder content and pressure applied to the binder/particle mixture while forming the backing structure 14. Therefore, as the particle size and the pressure increase, the binder content normally decreases. The optimum binder content also depends on other factors, such as the type of binder, the particle material used and the type of fabric, and can be determined by routine experimentation.

For example, the binder may be a liquid polyurethane MDI binder, in which case it is preferably present at a level of from about 4% to about 12% by weight for example if the backing consists primarily of chips or granules. The binder may contain further additives that are desirably in liquid form and which are compatible with the binder, such as colorants, plasticizers and perfumes. The binder may also contain other additives provided that they are suitable for addition in a liquid medium.

The binder may alternatively be a thermoplastic or thermosetting hot melt powder, in which case it is preferably present at a level from about 3% to about 10% by weight, for example if the backing consists primarily of chips or granules. A powdered binder may also contain other additives provided that they are suitable for addition in a powder medium.

In accordance with at least selected embodiments, the preferred ranges for binder content may thus be summarized as follows:

Backing of chips/granules: binder content in range from about 2% to about 20% by weight, preferably from about 4% to about 12% by weight for example with an MDI binder or from about 3% to about 10% by weight for example with a hot melt binder.

Backing with about 10% powder: binder content in range from about 9% to about 20% by weight, preferably about 14% by weight or more.

In exceptional cases, a binder content of about 25% or more by weight may be employed, even though this may lead to the formation of a skin.

A process for making the surface covering 10 of FIG. 1 with a backing structure of, for example, granulated particles of, for example, foam, cork or rubber will now be described with reference to FIG. 2, which is a schematic of an integrated processing line. In the illustrated process, a mixture of particles or crumbs, such as foam, rubber or cork particles P in blended relation with a desired binder B is delivered from a deposit station 20 that blends the particles and binder onto a motor driven carrier belt 22. To aid in establishing a uniform deposit of particles and binder across the carrier belt 22, doctor blade 23 or other suitable levelling device is positioned downstream of the deposit station 20.

The carrier belt 22 is made with a non-stick surface, for example, of polytetrafluoroethylene (PTFE)-coated woven glass fabric to prevent the applied materials from sticking to it. Alternatively, carrier belt 22 may be coated with a release layer or covered with a liner that facilitates release of the backing therefrom. For example, a backing sheet may be added between belt 22 and backing 14. In use, the carrier belt 22 advances in the direction of the arrows shown. This movement may be either stepwise or continuous depending upon the nature of the product being formed. As illustrated, the carrier belt 22 is disposed in opposing relation to motor driven compression belt 24 which moves in reverse angular relation to the carrier belt so as to establish a nip zone between the belts in the vicinity of heating (or cooling) elements or platens 26. Materials deposited on the carrier belt 22 thus undergo a degree of compression between the carrier belt 22 and the compression belt 24 and may simultaneously be heated or cooled.

In the illustrated process, a fabric forming the textile show surface 12 is conveyed from a roll 30 through coater 32 such as a submersion roll coater or the like wherein the film-forming composition 16 is preferably applied in saturating relation to the textile show surface fabric. The film-forming composition 16 is preferably a liquid urethane such as is readily available for coating hard wood floors and the like although polyesters, acrylics and other suitable protective coating or film forming compositions may likewise be utilized if desired. By way of example only, and not limitation, one suitable film forming protective composition is believed to be a polyurethane marketed under the trade designation STREETSHOE SUPER MATTE by Matrix Coatings having a place of business in Des Moines, Iowa. Such a composition has about a 20% by weight solids content and is preferably applied in a wet state at levels of from about 2 to about 100 ounces per square yard (from about 67.5 to about 3375 grams/m2) thereby yielding a dry add on weight after curing of from about 0.4 to about 20 ounces per square yard (from about 13.5 to about 675 grams/m2) in order to establish the preferably desired saturation and film-forming character. Of course, such levels are exemplary only and will depend upon the character of the fabric being saturated or coated. By way of example only, for a woven jacquard construction formed from 150 denier textured polyester yarn with a formation construction of about 132 ends per inch (2.54 cm) by about 51 picks per inch (2.54 cm) and a mass per unit area of about 5.4 ounces per square yard (182.25 grams/m2) prior to saturation it has been found that a wet application of about 8 ounces per square yard (270 grams/m2) yieldinq a dry add on following drying of about 1.6 ounces per square yard (54 grams/m2) may be desirable.

After exiting the coater 32, the saturated fabric is then passed through a curing station 34 such as a heater, oven, fan, or the like to cure the applied film forming composition 16 to form the exterior composite layer 18 as previously described. The fabric with the cured coating is then delivered in overlying relation to the particle/binder composition on the carrier belt 22 for subsequent compression and heating between the carrier belt 22 and the compression belt 24. Of course, it is to be understood that the coating of the show surface fabric need not be carried out in the same processing line as the heated compression. In fact, such steps are likely to be carried out in separate processing lines to facilitate processing freedom. For example, a roll 30 of saturated fabric 18 may be delivered to the processing line (range) shown in FIG. 2.

With reference again to FIG. 2 of the drawings, roll coater 60, such as a reverse roll coater, or other coating means such as an extruder or a film delivery system or the like may be used to add an adhesive or coating or film 50 to the back of fabric 12 or of saturated fabric 18. Also, roll coater 19, such as a reverse roll coater or other coating means such as an extruder or a film delivery system or the like, may be used to add an additional layer or layers or film 17 to composite 18 or to add material 16 on top of fabric 12, or the like. One or both roll coaters 60 and 19 or roll coater 32 may or may not be used depending on the desired structure. Further, material 16 may be added in one or more steps or layers. For example, coater 32 may add a first coating 16 and coater 19 may add a second coating of material 16. Roll coater 60 may likewise add a second coating of material 16 to the bottom of fabric 12. Hence, each of coaters 32, 60 and 19 may or may not be used and may be used to add material 16, 50 or 17 as desired. Materials 16, 50, and 17 may be the same material or different materials. For example, materials 50 and 17 may be the same as material 16, or material 17 may be, for example, a polyester wear layer while material 16 is a polyurethane coating. It is contemplated that additional ovens, heaters, fans, curing equipment, or the like may be added downstream of coaters 60 and 19 as necessary. If material 17 is a film, heat from heated platen 26 may be sufficient to fuse film 17 to coating 16. Further, a release liner or film may be added between belt 24 and material 16 or 17 if necessary.

After the exterior composite layer 18 is oriented on top of the particle binder composition, the pressure and heat (or cooling as needed) applied between the opposing belts 22, 24 causes the binder to bond or fuse the particles together thereby forming a stable backing structure 14 of desired thickness and resilience. In this regard, the applied pressure is preferably in the range of from about 0.01 to about 50 pounds per square inch or greater (from about 0.06895 kPa to about 344.75 kPa) and the temperature is preferably from about 300° to about 375° Fahrenheit (from about 148.9° C. to about 190.6° C.) although higher or lower temperatures may be used depending upon the materials of construction and pressure utilized. The combination of the saturating film-forming composition 16 or adhesive 50 and the binder B in the backing structure 14 concurrently bonds the exterior composite layer 18 to the backing structure 14. The layered structure formed preferably has the configuration illustrated in FIG. 1. As will be appreciated, a percentage of the exterior composite layer 18 may be depressed into and below the surface of the backing structure 14 if desired. After formation the resultant structure may be delivered to a tile cutter 31 (or rug, runner, or mat cutter) if it is to be used in a modular installation (or as a rug, runner or mat) or accumulated on a roll (not shown) if it is to be used in extended length segments such as roll goods, runners, broadloom, for example, 6 foot wide broadloom or to be cut later.

Of course, if desired, an additional layer of adhesive 50 such as hot melt urethane, polyester, polyamide, or the like or a primer or solvent may be added at the intersection between the particle/binder composition and the exterior composite layer 18. Such an adhesive may further stabilize the structure and provide enhanced protection against delamination. If used, such an adhesive layer may be applied in line such as on the bottom of the exterior composite layer 18 using, for example, roll coater 60 or other coating or application techniques such as spray coaters, extruders, thin film adhesive delivery, powdered adhesive delivery, or the like. It may also be applied to the top of the backing structure 14 by a spray coater, air knife, or other coating or application means if desired. The process line or lamination range of FIG. 2 may be used to also produce other structures such as shown, for example, in FIGS. 7, 12 and 14 as well as others.

Aside from in-situ fused particles of, for example, rubber and foam with binder, it is also contemplated that surface coverings of at least select embodiments of the present invention may incorporate backing structures of so called “rebond” foam wherein relatively small pieces or chips of scrap foam are formed into sheets with resilient binder between the foam pieces. FIG. 2A illustrates a processing line for the incorporation of, for example, such preformed rebond foam or other preformed backing into a layered structure as described in relation to FIG. 1. In FIG. 2A, elements corresponding to those described in relation to FIG. 2 are designated by corresponding reference numerals with a prime.

The process illustrated in FIG. 2A is substantially identical to that described in relation to FIG. 2 with the exception that the deposited mass of particles and binder is replaced by a preformed sheet 14′ of particles and binder such as rebond foam or other bound particles or particle mixtures or foams or resiliant materials. In order to secure the exterior composite layer 18′ to this preformed sheet 14′, a coater 60′ is used to apply a layer of adhesive 50′ such as urethane, polyester, polyamide, or the like to the underside of the exterior composite layer 18′ prior to mating with the preformed sheet 14′. Upon entering the nip zone between the opposing belts 22′, 24′ the pressure and heat applied causes the foam pieces to partially compress. The binder between the foam particles may fuse the particles together in the partially compressed state thereby forming a stable backing structure of desired thickness and resilience. In this regard, greater compression may give rise to reduced levels of cushioning resilience. The exterior composite layer 18′ is concurrently bonded to the backing structure by the intermediate adhesive layer 50′. After formation, the resultant structure may be delivered to a tile cutter 31′ if it is to be used in a modular installation or accumulated on a roll (not shown) if it is to be used in extended length segments or to be cut later. The surface covering such as flooring, floor tile, or floor covering produced by the process of FIG. 2A may look like the product of FIG. 7 with or without the backing sheet 452.

An alternative process for use in forming the illustrated and described structures is shown in FIG. 2B. In FIG. 2B, elements corresponding to those described in relation to FIG. 2 are designated by corresponding reference numerals with a double prime. In this process the particle/binder composition P, B is delivered onto the carrier belt 22″ from deposit station 20″ downstream of a dam to form a build-up or puddle of the particle/binder composition at the nip between a doctor or compression roll 37″ and the carrier belt 22″. The compression roll 37″ presses the exterior composite layer 18″ with or without layer 17″ into the particle/binder mass while simultaneously controlling the thickness of the particle/binder material. During this compression, it may be preferred that the underlying portion of heating elements 26″ raises the temperature of the layers to initiate fusion bonding. The formed structure thereafter passes between the carrier belt 22″ and a downstream compression belt 24″ to complete joinder. After formation, the resultant structure may be delivered to a tile cutter 31″ if it is to be used in a modular installation or accumulated on a roll (not shown) if it is to be used in extended length segments or to be cut later.

It is contemplated that one or more friction enhancing materials or layers 15 may optionally be added to the bottom of backing 14 of surface covering element 10 of FIG. 1. Such friction enhancing materials are described, for example, in U.S. patent application Ser. No. 10/209,050 (US Published Application US2004/0022991) incorporated by reference herein. Preferably, such friction enhancing materials provide additional lateral grip and some vertical stick. Also, backing 14 and/or material 15 may include magnetic or magnetizable particles or material to provide a magnetic attraction to, for example, metal flooring or metal raised access flooring. Further, material 15 may be covered with a releasable, removable, cover sheet to provide a peel-n-stick surface covering product. Optional lower layer, coating or film 15 may be applied in the ranges of, for example, FIG. 2 or 2A, upstream of particle/binder delivery, between belt 24 and tile cutter 31, downstream of cutter 31, during the packaging of the products, or during the roll-up of the formed composite.

At least certain embodiments are also readily adaptable to structures requiring substantial levels of internal dimensional stability. One exemplary structure for a surface covering 110 intended to have such internal dimensional stability is illustrated in FIG. 3 wherein elements corresponding to those in FIG. 1 are designated by corresponding reference numerals increased by 100. As shown, in the embodiment of FIG. 3, the surface covering 110 incorporates a multi-layer stabilized backing structure 114 having a stabilizing layer 142 such as a woven or non-woven glass or fibreglass material disposed between opposing layers 140 of particles and binder, such as recycled surface covering, cork, foam, rubber blends thereof, combinations thereof, or the like particles held together with one or more binders as previously described. In addition, an added layer of adhesive 150 such as a hot melt urethane, polyester, polyamide, or the like may be disposed between the exterior composite layer 118 and the upper surface of the backing structure 114. If desired, an optional backing sheet, textile or material 152 of, for example, woven or non-woven construction may be placed across the underside either with or without an intermediate adhesive layer and an underlying friction enhancing material 115. A backing material such as a nonwoven felt serves not only as a release layer but also may provide a moisture wicking, evaporation, or vapor transport feature to the product. The felt 152 may tend to wick water or moisture to the seams and out from under the flooring product. Also, felt 152 may allow vapor transport to the seams and out from under the flooring.

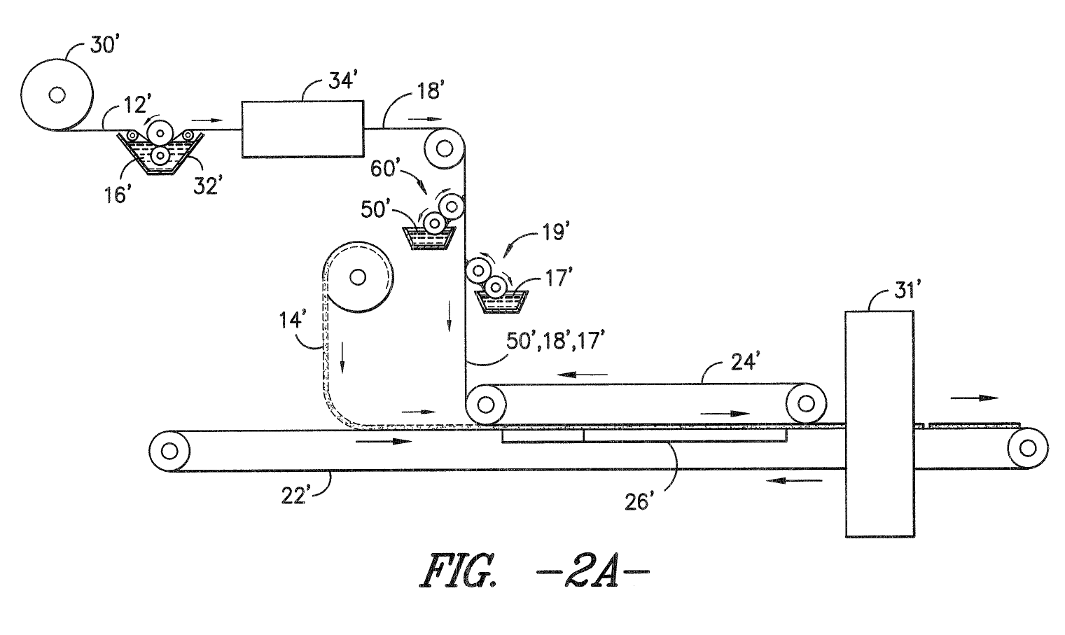

A process for making the surface covering 110 of FIG. 3 with a face 118 and a backing structure 114 incorporating layers of, for example, granulated particles of recycled surface covering, foam, cork, glass, coal fly ash, and/or rubber will now be described with reference to FIG. 4, which is a schematic of an integrated processing line (like that of FIG. 2). In the illustrated process, a backing sheet 152 of, for example, woven or non-woven textile material is delivered in overlying relation to a carrier belt 122. By way of example only, the backing sheet is preferably a non-woven felt material incorporating polyester and/or polypropylene fibers in any desired ratio between 100% polyester to 100% polypropylene. A friction enhancing material 115 may be added after the product is formed, added to backing 152 prior to product formation, or the like. At a downstream location, a first mixture of particles P in blended relation with a desired binder B is delivered from a first deposit station 120 that blends and deposits the particles and binder onto the backing sheet 152. To aid in establishing a uniform deposit of particles and binder across the backing sheet 152 a doctor blade 123 or other suitable levelling device is positioned downstream of the first deposit station 120. A layer of stabilizing material 142 such as woven or non-woven glass is thereafter applied in juxtaposed relation across the first particle and binder layer. Once the stabilizing layer 142 is in place, a second mixture of particles P in blended relation with a desired binder B is delivered onto the stabilizing layer 142 from a second deposit station 121 that blends and deposits the particles and binder. To aid in establishing a uniform deposit of particles and binder a doctor blade 125 or other suitable levelling device is positioned downstream of the second deposit station 121. A deposit head of deposit stations 120, 121 of FIGS. 4 and 20 of FIG. 2 may be, for example, moved back and forth across belts 122 and 22, respectively, to spread the particle and binder mixture across the belt.

The carrier belt 122, like belt 22, is made, for example, of PTFE-coated woven glass fabric to prevent the applied materials from sticking to it. In use, the carrier belt 122 advances in the direction of the arrows. This movement may be either stepwise or continuous depending upon the nature of the product being formed. As illustrated, the carrier belt 122 is disposed in opposing relation to motor driven compression belt 124 which moves in reverse angular relation to the carrier belt 122 to establish a nip zone between the belts in the vicinity of heating (or cooling) elements 126. Materials deposited on the carrier belt 122 thus undergo a degree of compression between the carrier belt 122 and the compression belt 124 and may simultaneously be heated and/or cooled.

In the illustrated process, a fabric forming the textile show surface 112 is conveyed from a roll 130 through a first coater 132 such as a submersion roll coater or the like wherein the film forming composition 116 is applied in saturating relation to the textile show surface fabric. The film-forming composition is preferably a liquid urethane such as is readily available for coating hard wood floors and the like although acrylics, polyesters, polyamides, and other suitable protective film forming compositions may likewise be utilized if desired. After exiting the coater 132, the saturated fabric is preferably then passed through a curing station 134 such as a heater, oven, fan, or the like to cure the applied film forming composition 116 thereby forming the exterior composite layer 118. The exterior composite layer 118 is then delivered to a second coater 160 such as a reverse roll coater or the like for application of the adhesive layer 150 to the underside surface. The surface composite 118 may then pass by a coater 119 such as a reverse roll coater to apply, for example, an additional wear layer, stain resist layer, soil resist layer, additional layer of composition 116, or the like. The fabric with the cured coating 116 and applied adhesive 150 and optional layer 117 is then applied in overlying relation to the upper layer of particle/binder composition for subsequent compression and heating and/or cooling between the carrier belt and the compression belt. Of course, it is to be understood that the coating of the show surface fabric need not be carried out in the same processing line as the heated and/or cooled compression. In fact, such steps are likely to be carried out in separate processing lines to facilitate processing freedom. Hence, the exterior composite 118 may be supplied in roll form with or without Layers 150, 117 and/or the like. It is contemplated that one or more of coaters 132, 160, and 119 may or may not be used for a particular structure and each may apply different materials.

After the exterior composite layer 118 is oriented on top of the particle binder composition, the pressure and heat (and/or cooling) applied between the opposing belts 122, 124 causes the binder to fuse the particles together thereby forming a stable backing structure 114 adhered to both sides of the stabilizing layer 142. In this regard, the applied pressure is preferably in the range of about 0.01 to about 50 pounds per square inch preferably about 0.1 to about 20 pounds per square inch and the temperature is preferably in the range of about 300° to about 375° Fahrenheit. The exterior composite layer 118, 117 is concurrently bonded to the backing structure 114 by the binder in combination with the optional applied adhesive 150. After formation, the resultant structure may be delivered to a tile cutter 131 if it is to be used in a modular installation or accumulated on a roll (not shown) if it is to be used in extended length segments or to be cut later.

Aside from fused particles of recycled, recyclable, renewable, natural, bio-based, bio-degradable or other materials such as recycled surface covering, cork, rubber and/or foam, it is also contemplated that surface coverings of at least selected embodiments may incorporate backing structures of, for example, so called “rebond” foam wherein relatively small pieces or chips of scrap foam are formed into sheets with resilient binder between the foam pieces. FIG. 4A illustrates a processing line for the incorporation of such preformed rebond foam or other particles or other preformed materials into a layered structure as described in relation to FIGS. 3, 2A, and 11. In FIG. 4A, elements corresponding to those described in relation to FIG. 4 are designated by corresponding reference numerals with a prime.

The process illustrated in FIG. 4A is substantially identical to that described in relation to FIG. 4 with the exception that the deposited layers of particles and binder are replaced by preformed sheets 140′ of, for example, particles and binder such as rebond foam. In the illustrated process, layers of adhesive such as urethane adhesive, hot melt adhesive, or the like are applied between each of the preformed sheets 140′ of rebond foam and the adjacent layers by coaters 161′ and 160′ to facilitate bonding. Upon entering the nip zone between the opposing belts the pressure and heat (and/or cooling) applied causes the foam pieces to partially compress. The binder between the foam particles may fuse the particles together in the partially compressed state thereby forming a stable backing structure of desired thickness and resilience. In this regard, greater compression may give rise to reduced levels of cushioning resilience. The exterior composite layer 118″ is concurrently bonded to the backing structure by the binder of the rebond sheet in combination with the applied adhesive 150′. After formation, the resultant structure may be delivered to a tile cutter 131′ if it is to be used in a modular installation or accumulated on a roll (not shown) if it is to be used in extended length segments or to be cut later. An optional lower layer 115 of, for example, friction enhancing material may be added upstream of backing 152′, after belt 124′, after cutter 131′, or during packaging or roll-up of product 110.

Of course it is to be understood that any number or other embodiments may be utilized for the surface covering depending upon contemplated use and performance requirements. By way of example only, one contemplated alternative construction is illustrated in FIG. 5 in which elements corresponding to those previously described are designated by like reference numerals within a 200 series. As will be appreciated, the surface covering 210 in FIG. 5 is of substantially the same construction as described in relation to surface covering 10 of FIG. 1 but with the addition of a backing sheet 252 of, for example, a textile or fabric, such as a woven or non-woven fibrous material disposed across the underside. In this construction, the backing sheet 252 is preferably held in place by the binder securing particles together in the backing layer 214. However, an additional adhesive layer may be used if desired. It is contemplated that such a structure may be formed by a process as illustrated and described in relation to FIG. 2 or FIG. 4 if the backing structure 214 is an in-situ particle and binder backing such as of a ground material such as crumb foam, rubber or cork or by a process as described in relation to FIG. 2A or FIG. 4A if the backing structure is a preformed sheet such as a sheet of preformed particles and binder, such as rebond foam or the like. In such a practice, the roll feeding the stabilizing material and one of the deposit stations (or one of the rolls feeding rebond sheet) of FIG. 4 or 4A is deactivated.

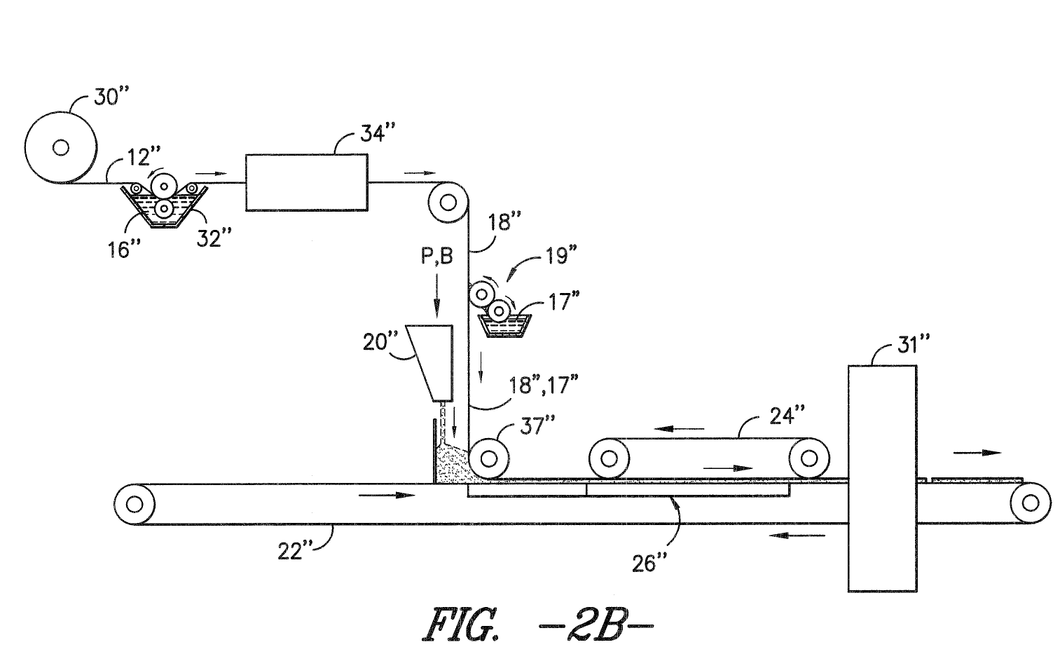

Another contemplated surface covering construction 310 is illustrated in FIG. 6 wherein elements corresponding to those previously described are designated by like reference numerals within a 300 series. In this construction a stabilizing layer 342 such as woven or nonwoven glass or the like is adhesively bonded below the saturated show surface material 318 by a layer of adhesive 350 such as a hot melt urethane or the like. It is contemplated that such a structure may be formed by a process as illustrated and described in relation to FIG. 4 if a ground backing material such as crumb foam, rubber or cork is used or by a process as described in relation to FIG. 4A if a sheet of preformed rebonded foam or the like is used. In such a practice the second deposit station (or downstream roll feeding rebond sheet) is simply deactivated. The resulting structure provides substantial internal dimensional stability and may be particularly suitable for articles such as carpet tile, floor tile, stabilized roll goods and the like.

Still another contemplated surface covering construction 410 is illustrated in FIG. 7 wherein elements corresponding to those previously described are designated by like reference numerals within a 400 series. In this construction, a particle/binder layer 440 of ground particles or preformed sheet construction, for example, a rebond foam sheet construction is adhesively bonded below the saturated show surface material 418 by a layer of adhesive 450 such as a hot melt urethane or the like. It is contemplated that such a structure may be formed by a process as illustrated and described in relation to FIG. 2, 4 or 4A. For example, such a construction may be formed by the process of FIG. 4 if an in-situ ground backing material such as crumb rubber or cork is used or by a process as described in relation to FIG. 4A if a preformed sheet of, for example, rebonded foam is used. In such a practice the roll feeding the stabilizing material and the second deposit station (or downstream roll feeding rebond sheet) is simply deactivated.

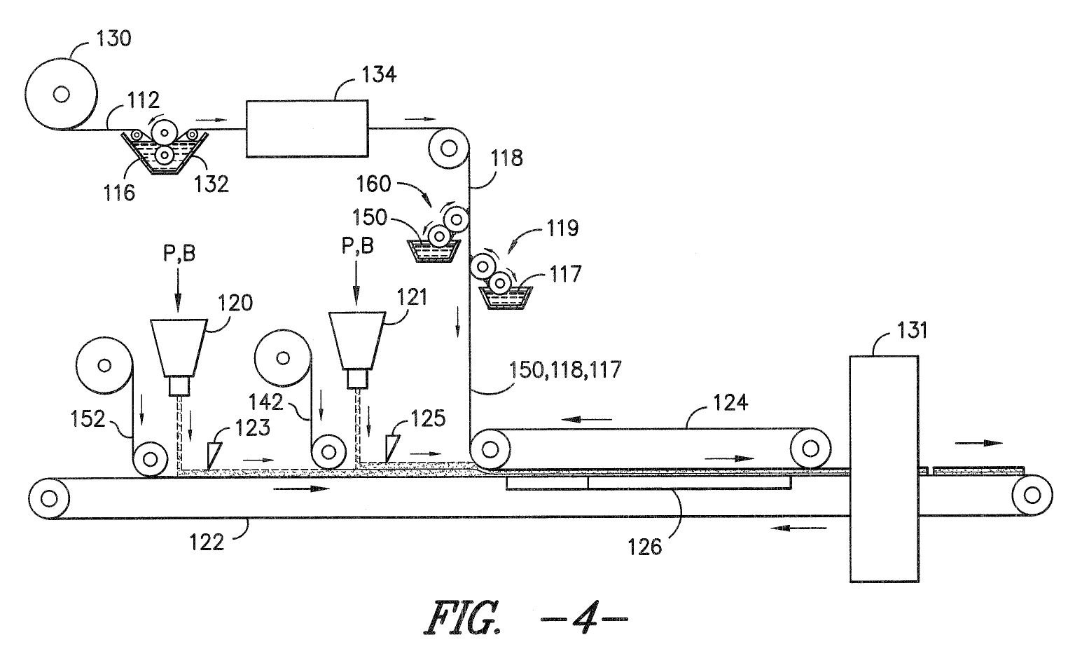

Yet another contemplated surface covering construction 510 is illustrated in FIG. 8 wherein elements corresponding to those previously described are designated by like reference numerals within a 500 series. As will be appreciated, this construction is a modification of that in FIG. 7 wherein the adhesive layer 550 is removed and an adhesive layer 554 is positioned between the backing structure 514 and a fibrous backing sheet 552. It is contemplated that such a structure may be formed, for example, by slightly modifying the process illustrated and described in relation to FIG. 4 if an in-situ ground backing material such as crumb rubber or cork is used or as described in relation to FIG. 4A if a preformed sheet of, for example, rebonded foam is used. In such practices an adhesive coater is placed upstream of the first deposit station (or first roll feeding preformed rebond) so as to coat a layer of adhesive across the top of the fibrous backing layer 552 prior to mating with upper layers. The adhesive coater treating the exterior composite layer, the roll feeding the stabilizing material and the second deposit station (or downstream roll feeding rebond sheet) are simply deactivated. Alternatively, deposit station 120 of FIG. 4 may be converted to a roll coater for applying adhesive 554 to backing 552. Adhesive layer 554 may be helpful in bonding backing 514 to, for example, a polyester or polypropylene nonwoven or felt backing 552. Optional additional layers 517 may be added.

Another contemplated surface covering construction 610 is illustrated in FIG. 9 wherein elements corresponding to those previously described are designated by like reference numerals within a 600 series. As will be appreciated, this construction is a modification of that in FIG. 1 or FIG. 8 wherein an adhesive layer 650 is disposed between face layer 618 and backing 640 and an adhesive layer 654 is disposed between the backing layer 640 and a fibrous backing sheet 652. It is contemplated that such a structure may be formed by slightly modifying the process illustrated and described in relation to FIG. 4 if an in-situ particle or ground backing material such as crumb rubber or cork and a binder is used or as described in relation to FIG. 4A if a preformed sheet of rebond foam is used. In such practices an adhesive coater is placed upstream of the first deposit station (or first roll feeding preformed rebond) so as coat a layer of adhesive across the top of the fibrous backing layer 652 prior to mating with upper layers. The roll feeding the stabilizing material and the second deposit station (or downstream roll feeding rebond sheet) are simply deactivated. Alternatively, deposit station 120 of FIG. 4 may be converted to a roll coater for applying adhesive 654 to textile backing 652. The structure 610 of FIG. 9 is especially suited for use of a preformed sheet of, for example, particles and binder as backing layer 640.

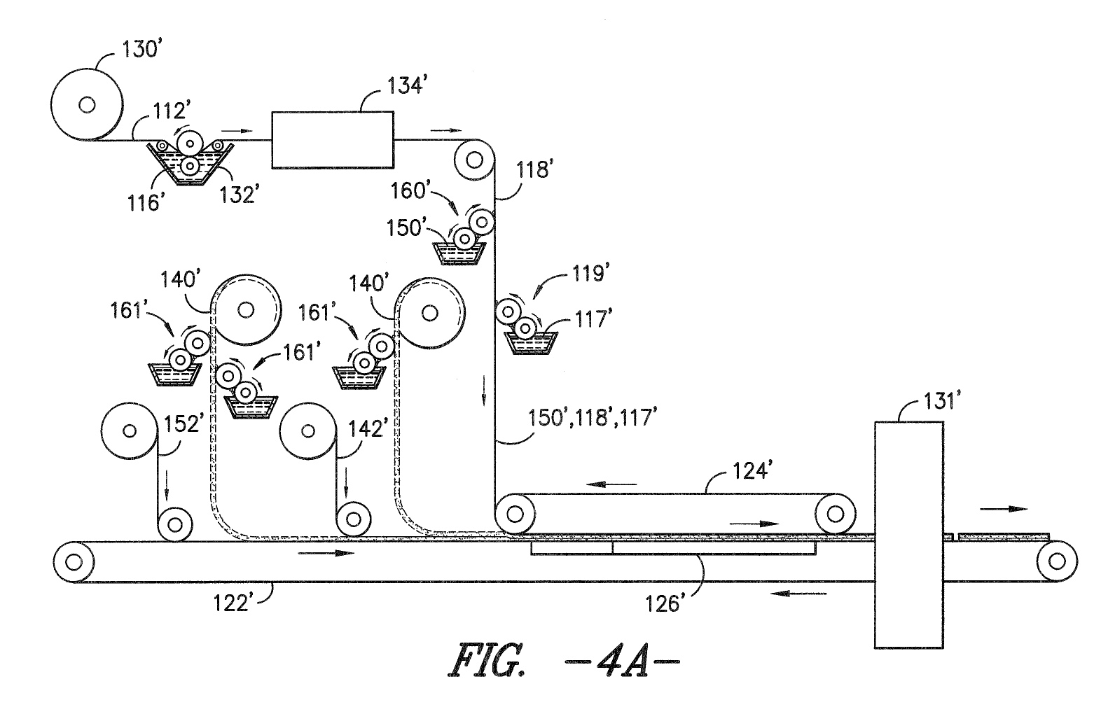

Still another contemplated surface covering construction 710 is illustrated in FIG. 10 wherein elements corresponding to those previously described are designated by like reference numerals within a 700 series. As will be appreciated, this construction is a modification of that in FIG. 6 wherein a scrim layer 757 such as polyester, polypropylene, glass, or the like woven or nonwoven mesh or net-like material (scrim) is disposed adjacent to the glass layer 742. It is contemplated that such a structure may be formed by a process as illustrated and described in relation to FIG. 4 if an in-situ ground backing material such as crumb rubber or cork and a binder is used or by a process as described in relation to FIG. 4A if a preformed sheet of, for example, rebond foam is used. In such a practice a scrim delivery roll is placed upstream of the roll delivering stabilizing material and the second deposit station (or downstream roll feeding rebond sheet) is deactivated. The resulting structure 710 provides substantial internal dimensional stability and may be particularly suitable for articles such as carpet tile, floor tile, modular products, and the like. For example, the scrim 757 may balance any shrinkage in the face material 712 to provide for a flat or slightly domed product. The additional stabilizing layer 757 may facilitate the elimination or removal of textile backing 752, use of a lighter face fabric 712, use of less composition 716 or 717, provision of a more durable, printable product, and/or the like.

Yet another contemplated surface covering construction 810 is illustrated in FIG. 11 wherein elements corresponding to those previously described are designated by like reference numerals within an 800 series. As will be appreciated, this construction is a modification of that in FIG. 3 wherein no additional adhesive is disposed between the exterior composite layer 818 and underlying layers. It is contemplated that such a structure may be formed by a process as illustrated and described in relation to FIG. 4 if an in-situ particle or ground backing material such as crumb rubber or cork and a binder is used or by a process as described in relation to FIG. 4A if a preformed sheet of, for example, rebond foam is used. In such practices the adhesive coater treating the exterior composite layer is preferably simply deactivated. Use of additional binder in backing 814 may facilitate elimination of additional adhesive layers.

As will be appreciated, if desired, additional layers of adhesive such as hot melt urethane, polyester, polyamide, and/or the like may be added at one or more of the intersections between any of the layers in any of the illustrated embodiments.

Thus, by way of example, a layer of adhesive may be added between the backing sheet and the adjacent backing layer and/or between the lower backing layer and the stabilizing layer (if utilized) and/or between the stabilizing layer (if utilized) and the overlying backing layer (if present). Likewise, it is contemplated that in any of the illustrated and/or described embodiments that the structure may be formed with or without a fibrous backing sheet. Also, additional binder may be added to the surface of any preformed particle sheets such as rebond foam. Further, an additional top layer or layers (17) or an additional bottom layer or layers (15) may or may not be added to a particular construction.

One contemplated benefit of at least certain embodiments or constructions is the ability to incorporate large percentages of recycled, renewable, recyclable, natural, bio-based, biodegradable, or other environmentally friendly or responsible materials, for example, waste products such as recycled weather stripping, recycled mats, recycled tires, carpet waste, used flooring, recycled surface coverings, processing waste, pre-consumer recycled content, post-consumer recycled content, post-industrial recycled content, and/or the like. Also, renewable resources such as cork or wood may be used alone or in combination with recycled materials. By way of example only, recycled filler materials such as surface coverings, face material, backing material, carpet, and/or the like may be ground up (or densified, crushed, sheared, shattered, high shear mixed, cryoground, pulverized, and/or the like) and blended with rubber particles (and/or cork particles) and binder prior to being deposited in the desired layered relation. In such a process, the ground material does not undergo melting but rather forms a constituent of the resilient matrix forming the backing. Thus, relatively large amounts of carpet waste, used flooring, or the like, may be incorporated without negatively impacting resiliency since the individual rubber particles (and/or cork particles) are not melted.

Another benefit of at least certain embodiments or constructions is that the utilized flat fabric in the exterior composite layer makes up a fairly small percentage by weight of the final structure. This weight percentage will normally be less than about 25% and will preferably be about 10% or less. Thus, the present surface covering product itself may be ground up and recycled as new backing material numerous times without undue contamination from fibrous constituents. In one particular example, the particle binder mixture is made up of one-third cork particles, one-third rubber particles, and one-third recycled surface covering particles. The one-third proportion can be based on either weight or volume. Binder such as MDI or MDE binder bonds the three different types of particles together.

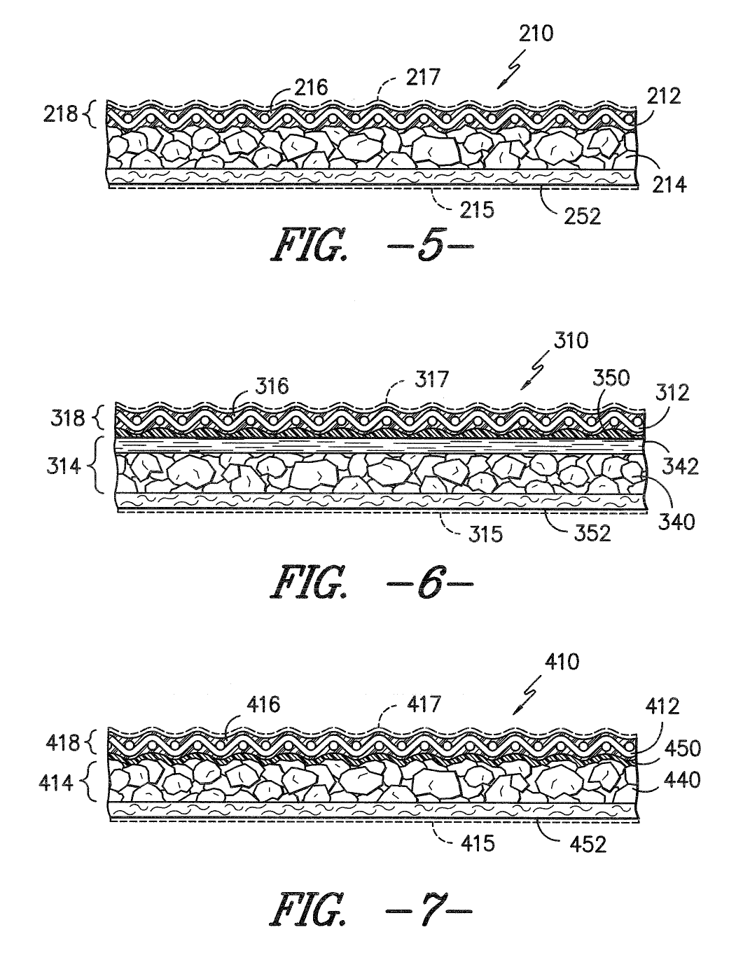

As previously indicated, one contemplated use of the present constructions is in the form of a surface covering tile or mat such as a floor tile, floor mat, or the like. An exemplary tile product 900 having a decorative show surface 975 defined by an exterior composite layer incorporating a decorative textile layer as previously described and overlying a particle backing 914 is Illustrated in FIGS. 12 and 13. Of course, it is to be understood that while a single layer particle backing 914 has been shown for simplicity, any of the described backing constructions may likewise be used if desired. Tile 900 may also include an optional cover layer 977, texturing 979 such as embossing, and friction enhancing layer 980. Likewise, while a square tile is illustrated, it is contemplated that other geometries such interlocking dovetails, chevrons, and the like may also be utilized.

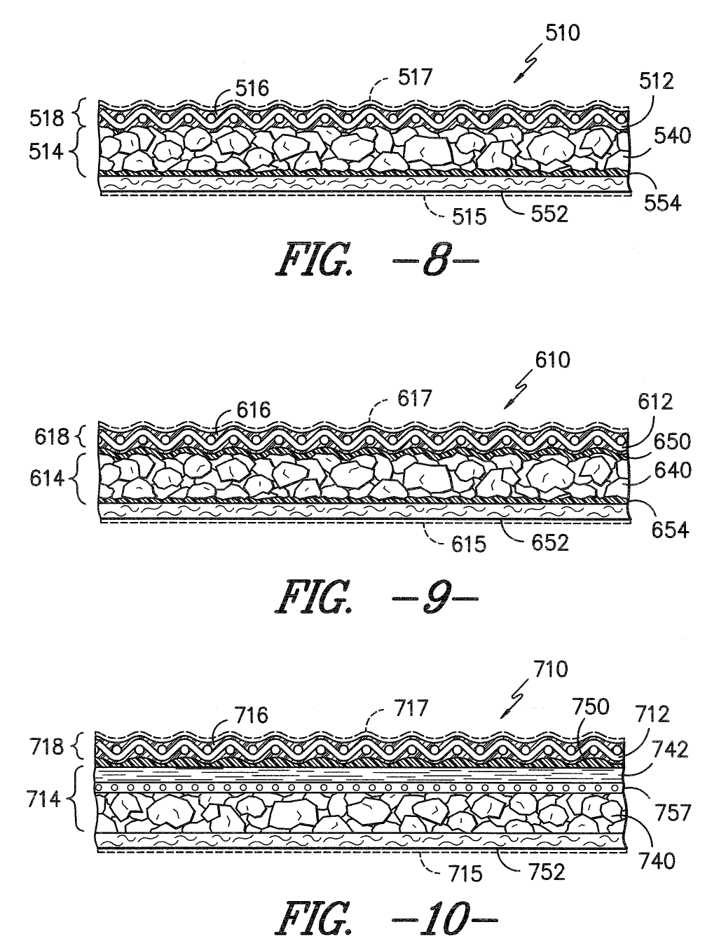

It is also contemplated that the materials forming the backing structures may themselves be used to provide a portion of an aesthetically pleasing show surface. By way of example only, in FIGS. 14 and 15 a surface covering tile or mat construction 1000 is illustrated having a decorative show surface 1075 defined by an exterior composite layer incorporating a decorative textile as previously described and overlying a particle backing 1014. As shown, a portion of the particle backing 1014 extends outboard of the exterior composite layer to define a decorative border. Such a construction may be useful in facilitating the substantially apparent seamless placement of tiles relative to one another across a surface since all edge borders will be of a generally matching appearance. Also, tile 1000 may include an optional top layer 1077, texturing 1079 such as embossing, and friction enhancing bottom layer 1080.

The materials forming the backing structures may also be used to provide a portion of an aesthetically pleasing show surface by using show surface fabric constituents of relatively open weave or knit construction (including mesh or net-like scrims) such that the backing is visible through the show surface fabric. Such open fabrics may be used alone or in combination with outboard borders. The bottom surface of any of the structures, constructions, or products as described herein may also be textured such as by embossing to, for example, enhance surface friction or the like.

In accordance with at least one possible embodiment, the construction of a textile face and a backing of at least one layer of agglomerated, adjoined particles are cured, cut into floor tile blanks, colored, printed or dyed, then the face is coated with a film or film-forming composition, and cured to form a clear, transparent or at least translucent film. The textile face, backing, and/or film may be textured, embossed, or the like prior to, during, or following coloration, printing, or dyeing.

It is usually easier to print or dye in register by printing or dyeing tile blanks or modular blanks as contrasted to printing or dyeing in broadloom form and then cutting out tiles. A backed floor tile blank (textile face, particle/binder backing, with or without an additional stabilizing layer, adhesive layer, textile backing, friction enhancing backing, and/or the like) with a light color or white textile face adapted to be colored, printed, dyed, or the like is adapted to be colored, dyed, printed, textured, treated, embossed, and can have, for example, an image, design or pattern applied thereto with relative precision (for example, by placing a square tile blank in a jig) to produce, for example, a floor tile with an image, pattern, or design which will register with an adjacent image, pattern, or design of an abutting floor tile in a floor tile installation. In this manner, a large image, pattern or design can be split up into a number of parts with each part on a separate tile. Alternatively, a tile pattern that is intended to mate with at least certain elements of an adjacent tile pattern can do so with precision and in registration to provide a very pleasing, seamless appearance to the overall installation.

Similarly, a tile blank or modular blank with a textile show surface saturated with a protective coating and a particle/binder backing may be cured and then colored, printed, dyed, and/or the like by, for example, a sublimation process (for example, dye sublimation printing, ink sublimation printing, inkjet sublimation printing, or the like) where the dye, ink, image, design, pattern, or the like passes through the protective film over the textile face and produces, for example, an image, coloration, design, or pattern visible through the transparent or translucent protective film. Sublimation is usually done on a polyester, polymer, or polymer coated surface.

For example, at high temperatures, solid dyes in the sublimation print can convert into a gas without becoming a liquid. The high temperature also opens the pores of the polymer film or fabric and allows the gas to enter. When the item is removed from the heat, the temperature drops, and the polymer pores close and the gas reverts to a solid state and becomes a part of the polymer film or fabric. Done correctly, it cannot be washed out or come off, unless the actual fibers or coating is damaged.

Most inkjet sublimation is done on white materials (substrates). The reason for this is because the inks are actually transparent, when sublimated, and need a white background to show up. White is the ideal background because it does not clash with the colors. Indeed, the white background actually enhances the colors.

In accordance with at least selected embodiments, a white textile, white coated textile, or white coating or film acts as the white substrate or background below a clear or transparent polymer coating or film such as a polyester coating for sublimation printing of an image, design or pattern on the surface covering. Also, one or more additional transparent coatings, films, or wear layers may be added over the polyester or other polymer coating or film.

In accordance with at least selected embodiments, a surface covering may be formed of layers made up of a single polymer or polymer type to facilitate recycling. For example, a surface covering may be formed of all polyolefin or all polyamide components.

In accordance with at least one embodiment, the face and/or backing of the surface covering meets or exceeds industry standards of, for example, flammability, smoke, toxicity, soil protection, antimicrobial odor, VOC, smoke density, pill test, lightfastness, crocking, static electricity, dimensional stability, Aachen test, dye fastness, durability, caster chair test, face weight, height, flexibility, size, cup, curl, bow, bias, skew, height variation, dimensional variation, stain protection, soil resistance, stain resistance, cleanability, commercial rating, residential rating, cushion, resilience, drape, seamability, appearance retention, compression, compression set, recycled content, recyclable content, renewable material content, and/or other industry standards, environmental standards, test ratings, and/or the like. For example, floor covering industry standards and/or specifications, more particularly, commercial flooring standards, residential flooring standards, institutional flooring standards (such as hospital, education and/or government standards), hospitality flooring standards, retail flooring standards, and/or the like.

In accordance with at least one embodiment, it is preferred that the particles and/or crumbs in the particle/binder backing structure or layer be about 6 mm or less (powder or granules).

The particle/binder backing of at least one embodiment is cured at about 100 psi (pounds per square inch) or less, preferably 50 psi or less, more preferably 25 psi or less, most preferably 10 psi or less. A low pressure cured particle/binder backing having some voids between the crumb (particles) and having, for example, crumb ranging in size mainly from about 2 mm to about 6 mm provides lateral grip with smooth and even carpeted surfaces. This lateral grip provides surface coverings, for example, flooring which tends not to creep or walk. Floor tiles having this lateral grip tend to stay in place after installed even without full spread adhesive installation, releasable adhesive installation, double sticky tape installation, and even free-lay or adhesive free installation.

The particles or crumbs of the particle/binder backing of at least certain embodiments may be selected from recycled, recyclable, renewable, waste, by-product, reclaimed, and/or virgin materials.

It is preferred to use recycled, recyclable, and/or renewable materials when possible. For example, recycled surface coverings, recycled flooring, recycled foam, recycled rubber, recycled cork, cork, wood, and combinations thereof, are preferable. Recycled flooring such as recycled carpet, recycled carpet tile, recycled waste carpet, recycled carpet, recycled trim waste, recycled carpet production waste, and the like can be processed to produce particles or crumbs of less than about 20 mm, preferably less than about 15 mm, more preferably less than about 10 mm, and most preferably less than about 6 mm (powder or granules). Although post consumer recycled content may be preferred, post industrial recycled content, and renewable, recyclable natural, bio-based, bio-degradable, and other environmental friendly or responsible materials may be used.

In accordance with at least selected embodiments, the present invention may relate to surface coverings such as floor coverings, wall coverings, furniture coverings, or the like, having a textile or fabric show surface, decorative layer, or face and an optional backing. The textile show surface, layer or face is optionally saturated, coated, covered, or includes a protective coating composition, film or wear surface such as a transparent resin or polymer material. In at least one exemplary embodiment, the textile show surface is in overlying relation to a backing of or including agglomerated adjoined particle elements. In at least another exemplary embodiment, the textile show surface is in overlying relation to a backing of or including a foam cushion layer. In yet another exemplary embodiment, the textile show surface is in overlying relation to a backing which is a blend or combination of a particle and a foam backing. In particular, but not exclusively, at least certain embodiments of the invention may relate to surface coverings such as floor coverings including but not limited to carpet, carpet tile, flooring, floor tile, rugs, area rugs, runners, mats, floor mats, stabilized broadloom, modular flooring, roll goods, or the like. The surface covering may incorporate a tufted, bonded, knit, woven, non-woven, needled, or the like textile or fabric show surface, face material, decorative textile layer, or the like. The textile layer may be saturated or coated with a film-forming composition which is desirably transparent or translucent when cured. Alternatively or in addition, the face yarn or fiber may include one or more coatings or layers such as clear, translucent and/or colored coatings or layers. For example, the face yarn may include a core yarn or fiber or filament or material covered with one or more coatings, cladding, sheaths, layers, wear layers, and/or the like. It is additionally desirable that the film-forming composition or the one or more coatings, films or layers is wear resistant, soil resistant, stain resistant, aesthetically pleasing, fusable, and/or the like. In one embodiment, the textile face may be disposed in overlyinq relation to a resilient backing formed from an agglomerated mass of particles, such as fractal particles, for example particles of virgin, recycled, recyclable, renewable, natural, bio-based, bio-degradable, and/or other environmentally friendly or responsible materials, such as recycled flooring, foam, rubber, and/or cork. The textile face and the resilient backing will generally be bonded together in adjoined relation. Optional adhesive layers, stabilizing layers, textile backings, and/or the like may be disposed above, in, and/or below the resilient backing. Friction enhancing, adhesive, or installation facilitating materials or coatings may be added to and/or on the underside of the backing. For example, the particle backing may include voids which increase lateral grip, reduce creep, and the like. Alternatively or in addition, a textile or fabric backing with a friction enhancing coating may be added below the particle backing or below a foam backing layer. Methods of making and or recycling such surface coverings are also provided.

In accordance with at least one embodiment, the present invention may relate to surface coverings such as floor coverings, wail coverings, furniture coverings, or the like, having a coated yarn textile show surface or face and an optional backing. The coated yarn textile show surface or face is optionally saturated, coated, covered or includes a protective coating composition, film or wear surface such as a transparent resin or polymer material. In at least one exemplary embodiment, the coated yarn textile show surface is in overlying relation to a backing of or including agglomerated adjoined particle elements. In at least another exemplary embodiment, the coated yarn textile show surface is in overlying relation to a backing of or including a foam cushion layer. In yet another exemplary embodiment, the textile show surface is in overlying relation to a backing which is a blend or combination of a particle and a foam backing. The textile face and the resilient backing will generally be bonded together in adjoined relation. Optional adhesive layers, stabilizing layers, textile backings, and/or the like may be disposed above, in, and/or below the resilient backing. Friction enhancing, adhesive, or installation facilitating materials may be added to and/or on the underside of the backing. For example, the particle backing may include voids which increase lateral grip, reduce creep, and the like. Alternatively or in addition, a felt backing with a friction enhancing coating may be added below the particle backing or below a foam backing layer. The coated face yarn may be a coated natural and/or synthetic fiber or filament or material yarn such as a polyester or polyolefin single or multiple fiber (staple or filament) yarn extrusion coated with a colored polyolefin or PVC polymer material over coated with a clear polymer wear layer such as a high density polypropylene. Methods of making such coated yarn surface coverings are also provided.

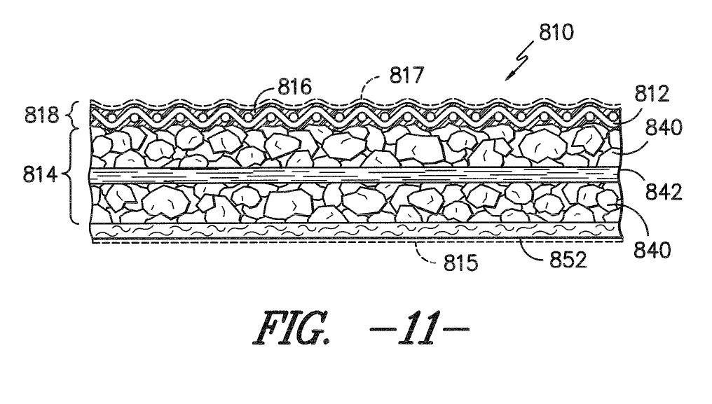

With reference to FIGS. 16 to 20 of the drawings and in accordance with at least selected embodiments, the face yarn, fiber, filament, material, or the like is shown as a coated yarn, fiber, filament, material, or the like useful in any of the constructions of, for example, FIGS. 1 to 15 or 22 to 28 or variations thereof. With reference again to FIG. 16, an exemplary coated yarn 1100 includes a core yarn 1102, a first coating 1104, and a second coating 1106. For example, core yarn 1102 is a natural and/or synthetic yarn (such as white polyester or polypropylene) coated with a first polymer or resin 1104 (such as colored PVC or polyolefin) thereafter coated with a second polymer or resin 1106 (such as clear polyester, polyolefin, acrylic, or polyurethane).

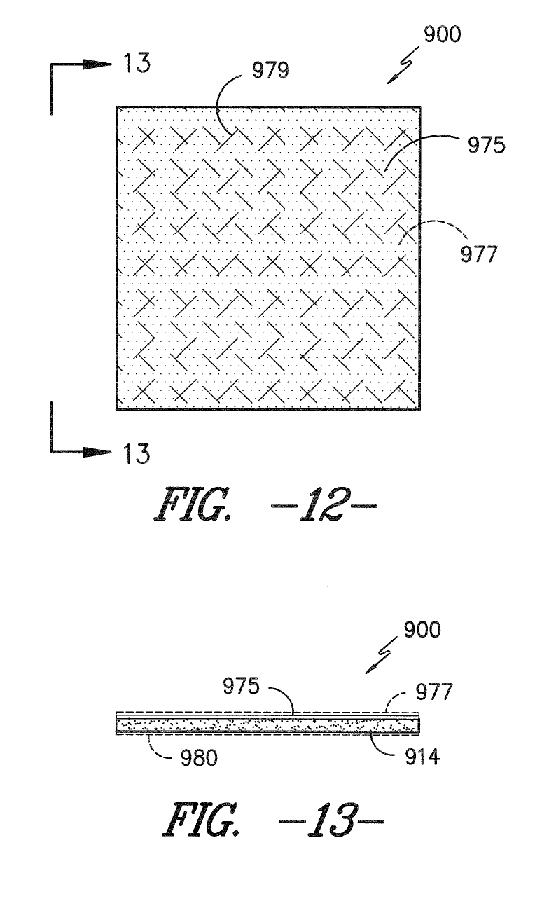

With reference again to FIGS. 17A and 17B, another exemplary coated yarn 1200 includes a core yarn 1202 and a coating 1204. For example, core yarn 1202 is a natural and/or synthetic yarn (such as colored polyester or polyolefin) coated with a polymer or resin 1204 (such as clear polyester, polyolefin, acrylic, or polyurethane). It may be preferred that the colored yarn be a brightly colored yarn such as a flat polyester yarn because the coating may deluster the yarn.

With reference again to FIG. 18, an exemplary coated yarn, fiber, filament, or material 1300 includes a core yarn, fiber, filament, or material 1302 and a coating 1304. For example, core 1302 is a natural and/or synthetic yarn, fiber, filament, or material (such as a clear, white, or colored polyester, polypropylene, or optical fiber, filament, or material) coated with a polymer or resin 1304 (such as clear polyester, polyolefin, acrylic, polyurethane, or the like).

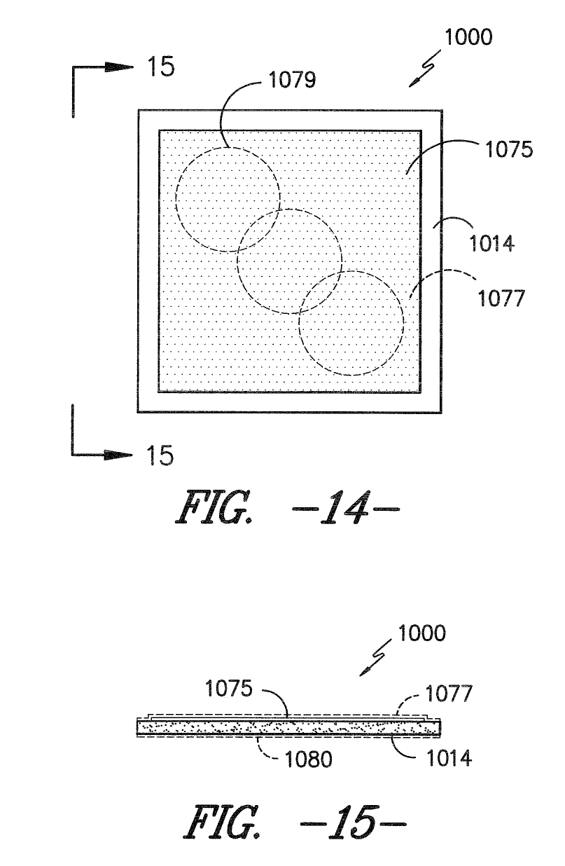

With reference again to FIG. 19, an exemplary coated yarn, fiber or filament 1400 includes a core yarn, fiber or filament 1402 and a coating 1404. For example, core yarn, fiber or filament 1402 is a natural and/or synthetic yarn, fiber or filament (such as a white or colored tri-lobal fiber or filament of polyamide, polyester or polyolefin) coated with a polymer or resin 1404 (such as a white, colored, or clear polyester, polyolefin, acrylic, PVC, or polyurethane).

With reference again to FIG. 20, an exemplary coated yarn 1500 like coated yarn 1100 of FIG. 16 includes a first core yarn 1502, a first coating 1504, and a second coating 1506 with the addition of a second core yarn 1508 and a third coating 1510 thereon. For example, core yarns 1502, 1508 are each a natural and/or synthetic yarn (such as white polyester or polyolefin) coated with a polymer or resin 1504, 1510 (such as colored PVC or polyolefin) thereafter coated with a second polymer or resin 1506 (such as clear polyester, polyolefin, acrylic, or polyurethane).

Hence, the coated face yarn, fiber, filament, material, or the like may have one or more single or multiple core yarns, fibers, filaments, or materials, one or more coatings, and the like. For example, the core yarn may range in size from about 150 to 5,000 denier, preferably about 500 to 2500 denier, a single coated yarn may range in size from about 1,000 to 10,000 or more denier, preferably about 2,000 to 8,000 denier, and a double coated yarn may range in size from about 2,000 to 20,000 or more denier, preferably about 3,000 to 18,000 denier.

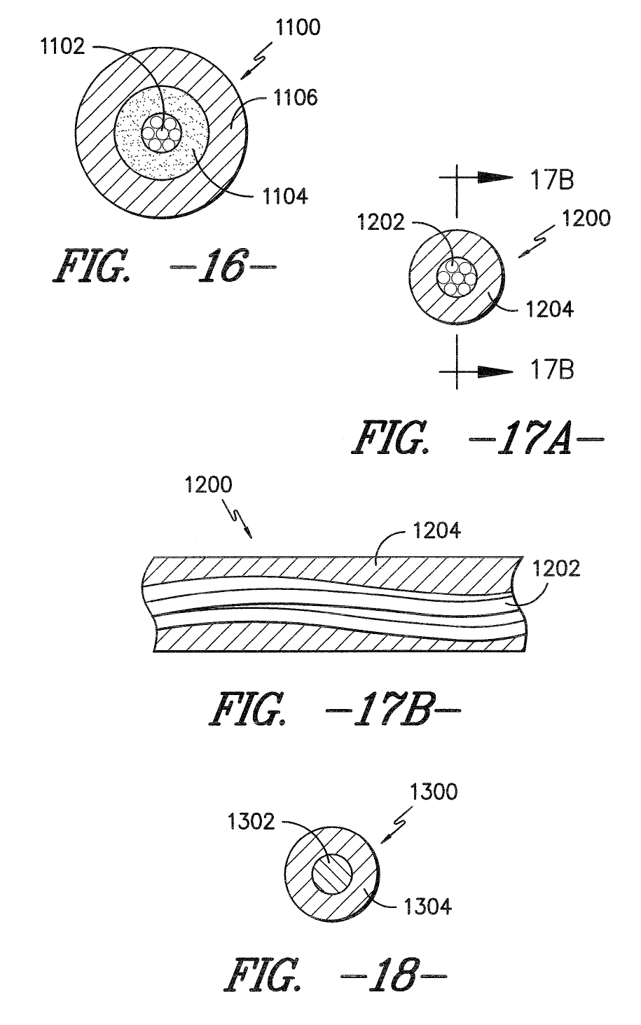

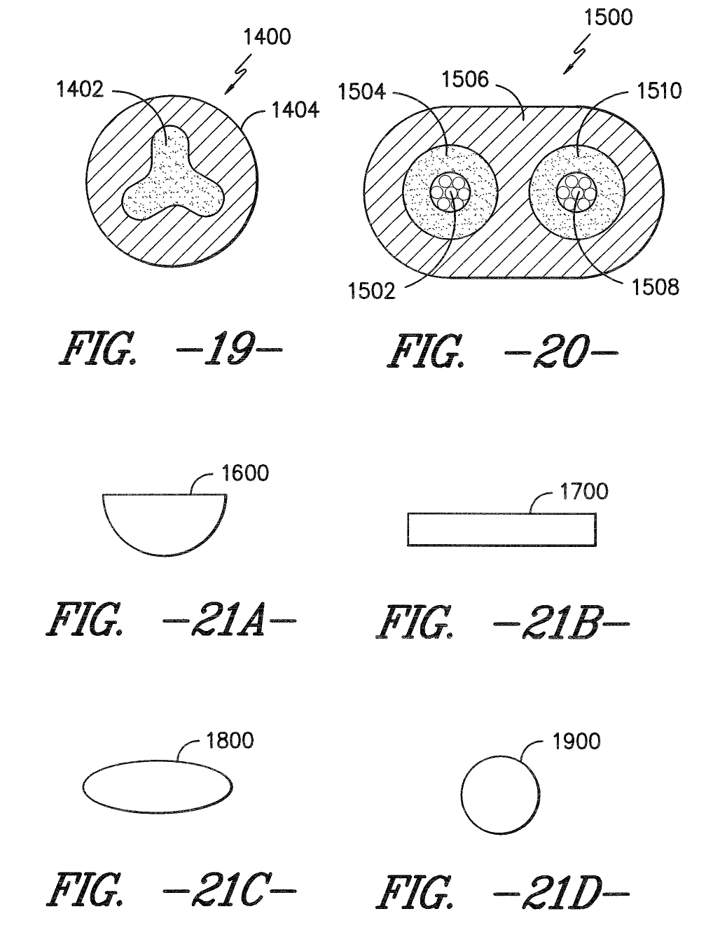

With reference to FIGS. 21A to 21D of the drawings, the face yarn, fiber, filament, or the like of at least selected embodiments may have different cross-sectional shapes (transverse shapes), for example, split fiber 1600 (semi-circular, FIG. 21A), slit fiber or tape 1700 (rectangular, FIG. 21B), oval 1800 (FIG. 21C), or circular 1900 (FIG. 21D). Even though selected shapes are shown, other shapes are contemplated as are well known in yarns, fibers, filaments, or materials. Also, the yarn may be textured, twisted, bulked, or the like. Further, the fibers may be staple or filament, continuous filament, monofilament, or the like.

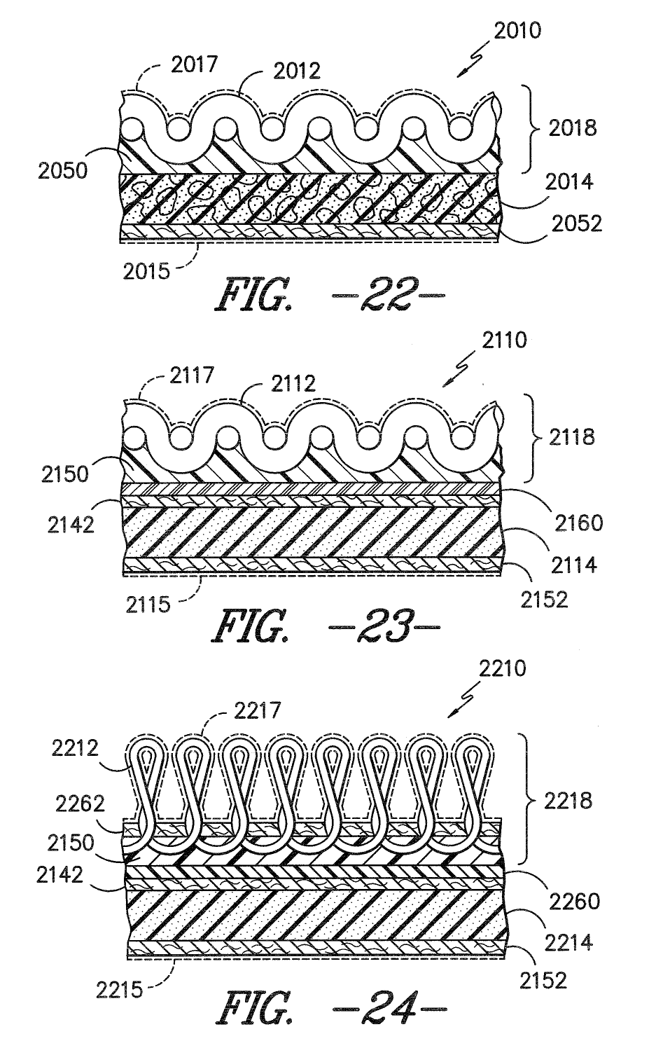

With reference to FIG. 22 of the drawings wherein elements corresponding to those previously described are designated by like reference numerals within a 2000 series, a woven surface covering construction or product 2010 includes a woven face material 2018 including yarns 2012 attached to a rebond foam layer 2014 by an adhesive or pre-coat 2050. Further, a backing material 2052 is attached or bonded to the bottom of foam layer 2014 by, for example, flame lamination or in-situ formation. Rebond foam backing constructions are disclosed for example in U.S. patent application Ser. Nos. 09/721,871 and 09/993,158 (US Published Application US 2002/0132085) and 10/209,050 (US Published Application US 2004/0022991) and British patent GB 2369294 to Higgins et al. which are hereby incorporated by reference as if fully set forth herein. Optional additional upper and lower layers 2017 and 2015 may be added.

With reference to FIG. 23 wherein elements corresponding to those previously described are designated by like reference numerals within a 2100 series and with regard to an alternative possibly preferred embodiment, a surface covering 2110 includes a woven or knit textile or fabric face 2118 having a yarn or fiber 2112 held in place by a precoat or adhesive 2150 which is bonded to an adhesive or tiecoat 2160 which in turn is bonded to a stabilizing layer 2142 which is joined to a foam layer 2114 which is bonded to a backing 2152. The precoat 2150 may be, for example, a latex or a hot melt or a urethane based adhesive. The tiecoat 2160 may be a hot melt adhesive. The precoat and tiecoat may be combined. Layer 2142 is preferably a non-woven glass mat, layer 2114 is preferably urethane foam, and layer 2152 may be a non-woven felt of polyester and/or polypropylene. Optional additional upper and lower layers 2117 and 2115 may be added.

Such virgin or filled foam backing constructions are described, for example, in U.S. Pat. Nos. 5,545,276; 5,948,500; 6,203,881; and 6,468,623 each hereby incorporated by reference herein.

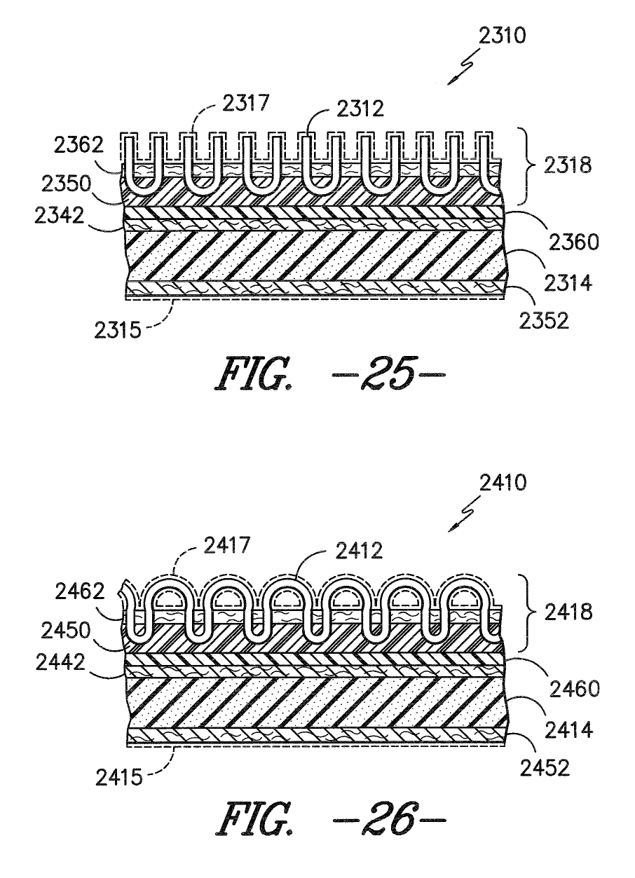

With reference to FIG. 24 wherein elements corresponding to those previously described are designated by like reference numerals within a 2200 series and with regard to another alternative possibly preferred embodiment, a surface covering 2210 includes a tufted textile or fabric face 2218 having a yarn or fiber 2212 tufted through a primary backing 2262 and held in place by a precoat or adhesive 2150 which is bonded to an adhesive or tiecoat 2260 which in turn is bonded to a stabilizing layer 2142 which is joined to a foam layer 2214 which is bonded to a backing 2152. The precoat 2150 may be, for example, a latex or a hot melt or a urethane based adhesive. The tiecoat 2260 may be a hot melt adhesive. The precoat and tiecoat may be combined. Layer 2142 is preferably a non-woven glass mat, layer 2214 is preferably urethane foam, and layer 2152 may be a non-woven felt of polyester and/or polypropylene. Optional upper and lower layers 2217 and 2215 may be added, or alternatively or in addition, yarn 2212 may be coated with a layer 2217 prior to tufting. Although a level loop pile is shown, it is contemplated that multi-level, textured, cut, loop, and/or cut and loop pile may be used.

With reference again to FIGS. 22 to 24, the face of each construction or composite may be coated with one or more protective layers. In a preferred example, the face yarn is an all polyolefin coated yarn (polyolefin core yarn, polyolefin coating) that is woven and then heat bonded (or fused). Also, a clear coating such as a clear wear layer of high-density polyolefin or polyester or acrylic may be added over the coated yarn. One exemplary clear coating material may be Surlyn polymer from DuPont. It may be preferred that the coated yarns are made by extrusion coating.

With reference to FIG. 25 wherein elements corresponding to those previously described are designated by like reference numerals within a 2300 series and with regard to another alternative possibly preferred embodiment, a surface covering 2310 includes a cut pile tufted textile or fabric face 2318 having a yarn or fiber 2312 tufted through a primary backing 2362 and held in place by a precoat or adhesive 2350 which is bonded to an adhesive or tiecoat 2360 which in turn is bonded to a stabilizing layer 2342 which is joined to a foam layer 2314 which is bonded to a backing 2352. The precoat 2350 may be, for example, a latex or a hot melt or a urethane based adhesive. The tiecoat 2360 may be a hot melt adhesive. The precoat and tiecoat may be combined, Layer 2342 is preferably a non-woven glass mat, layer 2314 is preferably urethane foam, and layer 2352 may be a non-woven felt of polyester and/or polypropylene. Upper and lower optional layers or films 2317 and 2315 may be added.

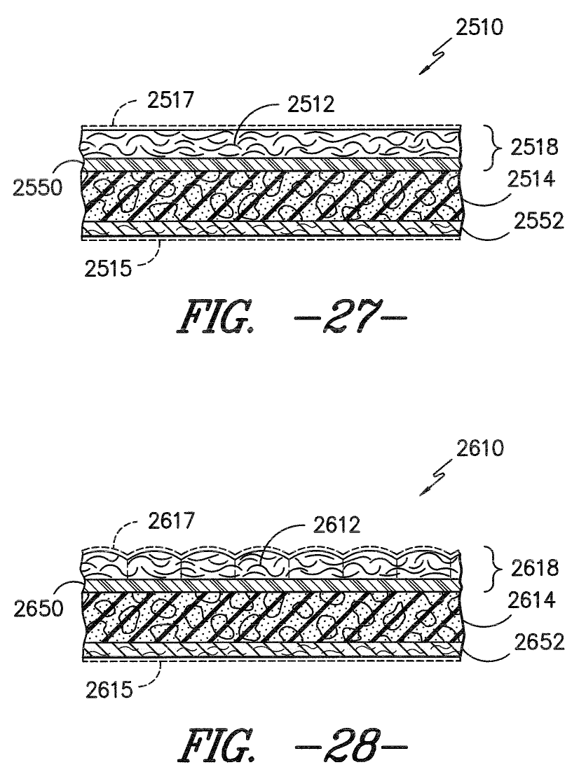

With reference to FIG. 26 wherein elements corresponding to those previously described are designated by like reference numerals within a 2400 series and with regard to another alternative possibly preferred embodiment, a surface covering 2410 includes a tufted textile or fabric face 2418 having a yarn or fiber 2412 tufted through a primary backing 2462 and held in place by a precoat or adhesive 2450 which is bonded to an adhesive or tiecoat 2460 which in turn is bonded to a stabilizing layer 2442 which is joined to a foam layer 2414 which is bonded to a backing 2452. The precoat 2450 may be, for example, a latex or a hot melt or a urethane based adhesive. The tiecoat 2460 may be a hot melt adhesive. The precoat and tiecoat may be combined. Layer 2442 is preferably a non-woven glass mat, layer 2414 is preferably urethane foam, and layer 2452 may be a non-woven felt of polyester and/or polypropylene. Optional upper and lower layers 2317 and 2315 may be added.

With reference to FIG. 27 of the drawings wherein elements corresponding to those previously described are designated by like reference numerals within a 2500 series, a non-woven surface covering construction or product 2510 includes a non-woven face material 2518 including yarns 2512 attached to a rebond foam layer 2514 by an adhesive or pre-coat 2550. Further, a backing material 2552 is attached or bonded to the bottom of foam layer 2514 by, for example, flame lamination or in-situ formation. Rebond foam backing constructions are disclosed for example in U.S. patent application Ser. Nos. 09/721,871 and 09/993,158 (US Published Application US 2002/0132085) and 10/209,050 (US Published Application US 2004/0022991) and British patent GB 2369294 to Higgins et al. which are hereby incorporated by reference as if fully set forth herein. Optional additional upper and lower layers 2517 and 2515 may be added.

With reference to FIG. 28 of the drawings wherein elements corresponding to those previously described are designated by like reference numerals within a 2600 series, a needled or needle punched surface covering construction or product 2610 includes a needled face material 2618 including yarns 2612 attached to a rebond foam layer 2614 by an adhesive or pre-coat 2650. Further, a backing material 2652 is attached or bonded to the bottom of foam layer 2614 by, for example, flame lamination or in-situ formation. Rebond foam backing constructions are disclosed for example in U.S. patent application Ser. Nos. 09/721,871 and 09/993,158 (US Published Application US 2002/0132085) and 10/209,050 (US Published Application US 2004/0022991) and British patent GB 2369294 to Higgins et al. which are hereby incorporated by reference as if fully set forth herein. Optional additional upper and lower layers 2617 and 2615 may be added.

In accordance with selected features or embodiments, the preferred yarn for the woven coated yarn face material is brightly colored, flat, monofilament polyester yarn, coated with HDPP with 4% oxide to improve abrasion, and the HDPP is cross-linked and the fabric is heat bonded to prevent yarn slippage.

In accordance with at least one particular embodiment, a backing is made up of a tri-layer composite of a flame laminated or adhesively bonded composite of a glass layer, a cushion layer, and a felt backing layer. The cushion layer may be a particle/binder layer, a foam layer, a foam/particle layer, or the like. It may be preferred that the composite backing be attached to the decorative face with a precoat or adhesive layer, such as hot melt, latex, polyurethane, or the like. A hot melt precoat may be preferred.

It may be preferred to laminate the backing to the decorative face using precise coating equipment such as LACOM coaters to precisely measure the optimum precoat or adhesive layer to achieve the desired tuft lock, lamination strength, flexibility, and/or the like. A hot melt or urethane adhesive may be preferred.

In accordance with at least selected embodiments, the backing below the decorative face is a thin, dense, flexible, resilient backing layer attached to the decorative face with or without a stabilizing layer therebetween. Heavy fillers may be preferred as they will produce a dense backing. Magnetic or magnetizable fillers may also be preferred.

In at least selected embodiments, it is preferred that the monofilament of the coated yarn is colored and the coating is clear. The coating may protect the yarn from soiling, add luster, or serve as a continuous sheet of protective film. The yarn may be multifilament but during extrusion the bulk may be pulled out of the yarn so there may be little advantage to using multifilament. The filament can be one or multiple colors put together and it can be any of various sizes or cross-sections. A recycled yarn in multiple controllable colors may be preferred.

In accordance with another backing example, a polymer foam forming composition may be used to produce either a high recycled carpet content hardback or a high recycled carpet content high density cushion. This may be achieved by scatter-coating granuals or chips of recycled carpet into a urethane foam puddle and either mechanically blending or simply letting the rolling action of the puddle blend the chips into the liquid foam. Alternatively, chips may be metered into the liquid foam in the piping of the foam through a static mixer. Such a process may benefit from the reduction of air into the liquid foam to make the foam a better adhesive. Small chips of, for example, recycled carpet, recycled carpet tile, recycled surface coverings, recycled trim waste, recycled urethane foam, recycled EPDM, recycled tire rubber, recycled flooring, recycled plastic, recycled glass, and/or the like may be used in this process for a more economical and recycled content backing in both hardback and cushion back foam. In one example, 25% chips by weight are added to 75% liquid foam by weight. A 25/75 chips/foam mixture by weight or by volume may be preferred.

While at least certain aspects, features, or embodiments have been illustrated and described in relation to certain potentially preferred embodiments and practices, it is to be understood that the illustrated and described embodiments and practices are illustrative only and that the present invention is in no event to be limited thereto. Rather, it is fully contemplated that modifications and variations to the present invention will no doubt occur to those of skill in the art upon reading the above description and/or through practice of the invention. It is therefore intended that the present invention shall extend to at least all such modifications and variations as may incorporate the broad aspects, embodiments, examples, or the like of the present invention at least within the full scope of the following claims and all equivalents thereto.

The words “comprises/comprising” and the words “having/including” when used herein, for example, with reference to the present invention are used to specify the presence of, for example, stated features, integers, steps, or components but do not preclude the presence or addition of one or more other features, integers, steps, components, groups thereof, and/or the like.

It is appreciated that certain features, aspects, embodiments, examples, or the like of the invention, which, for clarity, are described in the context of separate embodiments, may also be provided in combination in a single embodiment. Conversely, various features, aspects, embodiments, examples, or the like of the invention which are, for brevity, described in the context of a single embodiment, may also be provided separately or in any suitable sub-combination.

1. A surface covering comprising an exterior composite layer defining a show surface disposed in overlying relation to a single or multi-layer backing, wherein the exterior composite layer comprises a decorative textile or fabric layer optionally at least one of saturated, covered and coated with a protective film or film-forming composition and wherein the backing optionally comprises an agglomerated mass of particles bonded together in adjoined relation, a foam, a foam and particles, a felt, or combinations thereof.

2. The surface covering of claim 1, further comprising a fibrous backing sheet disposed across an underside portion of the backing.

3. The surface covering of claim 1, wherein the surface covering is a tile.

4. The surface covering of claim 1, wherein the decorative textile layer is at least one of a woven, knit, non-woven, needled, tufted, and flocked fabric.

5. The surface covering of claim 4, wherein the fabric is formed of coated yarn.

6. The surface covering of claim 1, wherein the decorative textile layer includes at least one upper protective wear layer or film.

7. The surface covering of claim 6, wherein the textile layer is formed of coated yarn.

8. The surface covering of claim 1, wherein the backing is at least one of flexible and resilient.

9. The surface covering of claim 1, wherein the show surface is disposed in overlying relation to a multi-layer backing.

10. The surface covering of claim 9, wherein the backing is bonded together in adjoined relation in combination with at least one stabilizing layer.

11. The surface covering of claim 10, wherein said stabilizing layer is at least one of woven or nonwoven glass.

12. The surface covering of claim 11, further comprising a fibrous backing sheet disposed across an underside portion of the backing.

13. The surface covering of claim 11, wherein the surface covering is a tile.

14. The surface covering of claim 1, wherein the backing is a particle and binder backing.

15. The surface covering of claim 14, wherein the backing is at least one of in-situ and preformed.

16. The surface covering of claim 1, wherein the backing is a foam or foam and particle backing.

17. A method of producing a surface covering with a coated yarn textile surface and a backing, comprising the steps of: mixing particles, for example particles of rubber and/or foam and/or cork with binder or with foam optionally with the addition of one or more fillers, agents or compounds; depositing the particle/binder or particle/foam mixture in a layer; placing an optionally coated, covered or saturated textile surface material on the deposited layer to form a multi-layer structure; pressing the multi-layer structure while setting the binder or foam with, for example, heat so that the particles are bonded to the binder or foam to form a backing optionally including voids between the pressed particles, and wherein the optionally coated textile surface material is bonded to the backing.

18. The method of claim 17, wherein the optionally coated textile surface material is at least one of printed or dyed before or after it is coated.

19. The method of claim 18, wherein the optionally coated textile surface material is sublimation printed.

20. The method of claim 17, wherein one or more additional wear layers are added over the optionally coated textile surface material.
